(19) United States
(12) Patent Application Publication
(10) Pub. No.: US 2026/0310430 A1
(43) Pub. Date: Oct. 8, 2026

(54) SOFTWARE SYSTEMS AND METHODS FOR A-OALP AMBIGUITY MITIGATION AND DISTRIBUTED ADAPTIVE COOPERATIVE SCHEDULERS

(71) Applicant: Kevin D. HOWARD, Mesa, AZ (US)

(72) Inventor: Kevin D. HOWARD, Mesa, AZ (US)

(21) Appl. No.: 19/651,685

(22) Filed: Apr. 18, 2026

Related U.S. Application Data
(63) Continuation-in-part of application No. 19/433,925, filed on Dec. 28, 2025, now Pat. No. 12,710,942.
Application No. 19/433,925 is a continuation-in-part of application No. 19/301,590, filed on Aug. 15, 2025, now Pat. No. 12,625,689.
Application No. 19/301,590 is a continuation of application No. 19/171,172, filed on Apr. 4, 2025, now Pat. No. 12,411,671.
(60) Provisional application No. 63/869,268, filed on Aug. 23, 2025.
(60) Provisional application No. 63/949,547, filed on Dec. 28, 2025.

(51) Int. Cl. G06F 8/41

(52) U.S. Cl. CPC G06F 8/443

(57) ABSTRACT

A distributed adaptive cooperative scheduler (DACS) method is disclosed for real-time execution of software represented as advanced output-affecting linear pathways (A-OALPs). The method provides processing and memory resources, associates each A-OALP with time and resource complexity information, and receives start and due times for execution. An A-OALP selection table selects one or more A-OALPs based on input variable attributes, and a maximum number of processing elements is computed using the complexity values. The selected A-OALPs are transmitted to a resource checker that predicts processing time and generates a go/no-go signal relative to the due time. When sufficient resources are indicated, execution of the selected A-OALPs is initiated, and processing elements are dynamically reallocated to compensate for late data arrival or upstream delays, enabling deterministic real-time behavior without reliance on a conventional operating system scheduler.

### CROSS-REFERENCE TO RELATED APPLICATIONS

This Application is a continuation-in-part of U.S. patent application Ser. No. 19/433,925, filed Dec. 28, 2025, which is a continuation-in-part of Ser. No. 19/301,590, filed Aug. 15, 2025, which is a continuation of U.S. patent application Ser. No. 19/171,172, filed Apr. 4, 2025 and now issued as U.S. Pat. No. 12,411,671, and U.S. patent application Ser. No. 19/433,925 claims priority to and the benefit of U.S. Provisional Patent Application No. 63/869,268, filed Aug. 23, 2025, and this Application claims priority to and the benefit of U.S. Provisional Patent Application No. 63,949,547, filed Dec. 28, 2025; with each of the referenced and identified patent applications and disclosures fully incorporated herein by reference.

### TECHNICAL FIELD

The present invention relates generally to algorithm decomposition, software parallelization, serial and parallel software analytics generation, and more particularly to advanced output-affecting linear pathways (A-OALPs) expanded to mitigate temporal, spatial, and output (transformational) ambiguities and to create distributed scheduling, and operating system-less control.

### BACKGROUND OF THE INVENTION

U.S. Pat. No. 11,520,560, Computer Processing and Outcome Prediction Systems and Methods, discusses different temporal ambiguities that are a direct consequence of Alan Turing's computational model. The first, called Turing's first temporal ambiguity, TFTA, comes from the fact that the execution pathway is unknown until execution because the non-loop control conditions are unknown until they are executed. Execution of the non-loop control conditions redirects the process flow of an algorithm, giving ambiguity in the processing time. TFTA is directly addressed using A-OALP decomposition because, as shown in U.S. Pat. No. 12,411,671, Software Systems and Methods for Advanced Output-Affecting Linear Pathways, the A-OALP execution pathway is selected prior to its execution. Turing's second temporal ambiguity, called TSTA, occurs when there are one or more non-loop control conditions within looping structures. A looping structure containing a non-loop control condition is a special case of loops on an execution pathway. Unlike known technology, which relegated TSTA processing time to a bounded statistical solution, this document shows that there are two types of TSTA issues and how to non-statistically mitigate both. For Turing's third temporal ambiguity, herein called TTTA, the number of loop iterations of a time-affecting loop change as a function of the processing performed within the loop. This has the effect of obscuring the processing time. TTTA was detected, issuing an error condition. This document shows that, as long as there is a value of the variable in the looping structure that changes the loop ending condition, the TTTA condition is no longer ambiguous. As discussed in U.S. patent application Ser. No. 19/433,925, Software Systems and Methods for A-OALP Execution on Reversible Logic or Measurement-Based Gates, there are three states associated with each A-OALP: output complexity, advanced time complexity, and advanced space complexity. It was shown that the behavior of each state is similar but differs in its operational domain: output (transformation), time (processing time), and space (memory allocation) respectively. The concepts of Turing's temporal ambiguities require expansion into both output and spatial ambiguities.

The scheduling of computer software tasks has remained largely unchanged for decades. Most schedulers behave like the Windows task scheduler or the Unix/Linux Cron scheduler. The primary concept is that at a certain future date/time the resources required to process a computer software task (processors, threads, dataflows) is scheduled for execution on a computer system. A common concern with schedulers is ensuring that the work will complete by some deadline. Since A-OALPs use spare cores, cores not used by the operating system (i.e., not core 0), and have their own thread-handling system, they can behave deterministically. The use of A-OALPs ensures that a non-real-time operating system can behave as if it were a real-time operating system. Typically, there is a centralized scheduling system that allocates and deallocates the resources required to run a job as well as starting or aborting the job itself. Heuristics are used to ensure that a job will either complete when required or that the job will be suspended or canceled if too much time has taken place. This makes poor use of most modern hardware systems as centralized control leads to processing bottlenecks and system fragility. These problems can be overcome by combining the distribution of the resource allocation and task start times while deterministically calculating if a processing job will complete within its required time period or be able to make up for lost time.

With understood techniques, receiving data late in the middle of a process could cause unrecoverable errors downstream from the late data receipt event. There is no known scheduler-based method for regaining lost processing time. Scheduling historically revolves only around time with no provision for taking into consideration various resources. To overcome these problems without introducing unwanted system delays requires the ability to dynamically allocate system resources to increase the performance of downstream processing such that delays are automatically mitigated.

In the modern era where data centers consume a large percentage of generated power and where compute load variances from data centers can cause catastrophic spikes in power use, a resource like energy availability is now critical in ensuring that the power grid remains viable. There is no known technique or technology directly linking power availability or power service-level agreements with server and processing core-level use scheduling.

### SUMMARY OF THE INVENTION

The technology mentioned above discusses the creation of new output-affecting linear pathway (A-OALP) network pathways and reversible logic A-OALPs that generate advanced output from a set of inputs. Each advanced output contains all input values associated with each linked A-OALP. This is especially relevant to reversible neural networks as advanced output tracks the outputs of all nodes to their associated inputs all the way to the initial network inputs. Advanced outputs are used herein as the storage method of a recurrent neural network (RNN) in a way that eliminates the vanishing gradient problems of RNNs. Also discussed herein is the use of automatic A-OALP regeneration in linked A-OALP compression and the use of linked A-OALPs with advanced outputs to predict object time-based sequences of events, known herein as object behavior, and their backpropagation through time.

The present invention first completes the description of various ambiguities that are a logical result of Alan Turing's and Alonzo Church's formalization of algorithms and computation. These ambiguities include: Turing's Second and Third Temporal Ambiguities; Turing's First, Second, and Third Spatial Ambiguities; and Turing's First, Second, and Third Output (transformational) Ambiguities.

The present invention goes into new detail on the impacts of using A-OALPs as the nodes of neural networks. This includes using the context-aware, reversible parallel A-OALP processing framework to define objects and their behavior, and compute appropriate responses to the object's predicted behaviors. Linked A-OALPs over time is shown to be useful in solving the vanishing gradient problems of recurrent neural networks, recursive cascade correlation neural networks, and recursive neural tensor networks.

The present invention details a new model of software scheduling. Rather than a central system managing the allocation of the software code's use of servers, processors, cores, and memory, herein distributed adaptive cooperative schedulers (DACSs) are defined. Each lowest-level DACS is shown to interact with a server's resource checker to locally manage A-OALP selection as well as perform processor, core and memory allocation. Since A-OALPs with a DACS can allocate and de-allocate all required system resources as well as determine the algorithms to be executed, and since safe execution removes external attack surfaces, there is no longer a need for an operating system (OS). This concept is called OS-less execution.

In the post-quantum era, encryption is problematical as Grover's algorithm can find the link between a key and the underlying diffusion pattern, and Shor's algorithm is used to break encryption that relies on factoring large semiprime numbers. The present invention extends A-OALP-based encryption by using multiple linked A-OALPs to encrypt and using the associated reverse A-OALPs to perform decryption. Both keyless and “broken” key models are discussed, each of which is shown to be resistant to both Shor's and Grover's quantum algorithms.

The concept of compression is also extended into the new concept of supercompression, which is used to define a form of linked A-OALP execution herein called secure execution. In secure execution, only the currently executing A-OALP in the linked A-OALPs is decompressed while all other A-OALPs in the composed list of A-OALPs remain compressed, greatly decreasing program memory requirements. The concept of supercompression is extended to include neural networks and time series neural networks.

In various embodiments, a DACS method is provided for real-time execution of software represented as A-OALPs. The method provides processing and memory resources, associates each A-OALP with time and resource complexity information, and receives start and due times for execution. An A-OALP selection table selects one or more A-OALPs based on input variable attributes, and a maximum number of processing elements is computed using the complexity values. The selected A-OALPs are transmitted to a resource checker that predicts processing time and generates a go/no-go signal relative to the due time. When sufficient resources are indicated, execution of the selected A-OALPs is initiated, and processing elements are dynamically reallocated to compensate for late data arrival or upstream delays, enabling deterministic real-time behavior without reliance on a conventional operating system scheduler.

In various embodiments, a DACS method comprises providing processing and memory resources configured to execute software, representing the software as one or more A-OALPs having associated time and resource complexity information, receiving an expected start time and an expected due time for execution of the one or more A-OALPs, selecting at least one A-OALP based on one or more input variable attribute values using an A-OALP selection table, computing a maximum number of processing elements for the selected at least one A-OALP using at least advanced time and resource complexity values, transmitting the selected at least one A-OALP to a resource checker, determining, via the resource checker, a go/no-go signal based on a predicted processing time relative to the expected due time, initiating, when the go/no-go signal indicates sufficient resources, execution of the selected A-OALP, and dynamically reallocating one or more processing elements to compensate for late data arrival or upstream delays.

### BRIEF DESCRIPTION OF THE DRAWINGS

The accompanying drawings, which are incorporated herein and form part of the specification, illustrate various embodiments of the present disclosure and, together with the description, further explain the principles of the disclosure and enable a person skilled in the pertinent art to make and use the embodiments disclosed herein. In the drawings like reference numbers indicate identical or functionally similar elements.

FIG. 1 shows a source code example of Turing's second temporal ambiguity, in accordance with embodiments of the present invention.

FIG. 2 shows a source code example of Turing's third temporal ambiguity, in accordance with embodiments of the present invention.

FIG. 3 shows a source code example of Turing's first spatial ambiguity, in accordance with embodiments of the present invention.

FIG. 4 shows a source code example of Turing's second spatial ambiguity, in accordance with embodiments of the present invention.

FIG. 5 shows a source code example of Turing's third spatial ambiguity, in accordance with embodiments of the present invention.

FIG. 6 show a source code example of Turing's first output (transformational) ambiguity, in accordance with embodiments of the present invention.

FIG. 7 shows a source code example of Turing's second output (transformational) ambiguity, in accordance with embodiments of the present invention.

FIG. 8 shows a source code example of Turing's third output (transformational) ambiguity, in accordance with embodiments of the present invention.

FIG. 9 shows a diagram of an example of an object detection and identification feed-forward neural network, in accordance with embodiments of the present invention.

FIG. 10 shows a diagram of an example of an object detection and identification feed-forward neural network with a single node highlighted, in accordance with embodiments of the present invention.

FIG. 11 shows two diagrams of the highlighted single node depicted first as a TALP and second as a set of parallel A-OALPs, in accordance with embodiments of the present invention.

FIG. 12 shows a diagram of the extended context-aware reversible parallel A-OALP processing framework. This extension combines all maxCores within the coordination state of the framework and exposes the resultant Pₘₐₓ, in accordance with embodiments of the present invention.

FIG. 13 shows a diagram of the advanced extended context-aware reversible parallel A-OALP processing framework, making it possible to include any computational resource required for processing an A-OALP, not just the space complexity (dynamic memory allocation). Here, both advanced time and advanced reverse time complexity are calculated, in accordance with embodiments of the present invention.

FIG. 14 shows an example of a multivariable A-OALP selection table, in accordance with embodiments of the present invention.

FIG. 15 shows a simple diagram of the new software scheduling concept A-OALP group scheduling that allocates a set of processing elements to a group of A-OALPs, which allows the A-OALPs within that group to allocate processing element resources on their own, in accordance with embodiments of the present invention.

FIG. 16 shows a diagram of linked A-OALP group scheduling that allocates a set of processing elements to a group of linked A-OALPs, which allows the A-OALPs that are linked within that group to allocate processing element resources on their own, in accordance with embodiments of the present invention.

FIG. 17A shows a diagram of the distributed adaptive cooperative scheduler (DACS) used to allow temporally linked A-OALPs or temporally linked A-OALP neural networks to manage their own resources, given only the start and end time goals as well as a set of resources, in accordance with embodiments of the present invention.

FIG. 17B shows a resource check table, in accordance with embodiments of the present invention.

FIG. 17C shows a heap space-time variable allocation table, in accordance with embodiments of the present invention.

FIG. 18 shows a diagram of tiered distributed adaptive cooperative schedulers (DACS) used to control geographically dispersed scheduling, in accordance with embodiments of the present invention.

FIG. 19 shows two graphs, the first a single input, single output A-OALP composite from an array of A-OALPs arranged linearly from left to right and the second, the inverse of the first, in accordance with embodiments of the present invention.

FIG. 20 shows two graphs, the first a single input, single output A-OALP composite from an array of A-OALPs arranged linearly from right to left and the second, left to right with a stride of one, skipping every other A-OALP in the array, in accordance with embodiments of the present invention.

FIG. 21 shows a graph of a single input, single output A-OALP composite from an array of A-OALPs arranged linearly from left to right with a stride of two, skipping every two A-OALPs in the array, in accordance with embodiments of the present invention.

FIG. 22 shows two single input, single output A-OALP composites in a circular arrangement, in accordance with embodiments of the present invention.

FIG. 23 shows left and right circularly arranged A-OALP composites, each with a starting offset of one, in accordance with embodiments of the present invention.

FIG. 24 shows multiple circularly arranged A-OALP composites with different offsets or strides used to encrypt a vector of plaintext, in accordance with embodiments of the present invention.

FIG. 25 shows additional circularly arranged A-OALP composites with both offsets and strides, in accordance with embodiments of the present invention.

FIG. 26 shows an array of plaintext folded into one, two, and three dimensions, in accordance with embodiments of the present invention.

FIG. 27 shows a circular array of plaintext used in circular A-OALP composites, in accordance with embodiments of the present invention.

FIG. 28 shows the inputs and outputs of an algorithm decomposed into two A-OALP source values tables, in accordance with embodiments of the present invention.

FIG. 29 shows the input values of a source values table folded into two dimensions with a key used to provide cross-dimensional permutation, in accordance with embodiments of the present invention.

FIG. 30 shows object behavior process flows, in accordance with embodiments of the present invention.

FIG. 31 shows object behavior selection from inputs via a selection table, in accordance with embodiments of the present invention.

FIG. 32 shows a diagram depicting the overall object and object behavior detection and identification, prediction, and response elements, in accordance with embodiments of the present invention.

FIG. 33 shows a graph of six overlapping detected and identified object behaviors, each with one or more temporally linked A-OALPs that define the behaviors over time, in accordance with embodiments of the present invention.

FIG. 34 shows an example of the linked A-OALPs that define the behavior of the second set of temporally linked A-OALPs of FIG. 33 as a list of source values tables, one per A-OALP output complexity as they appear in advanced output, in accordance with embodiments of the present invention.

FIG. 35 is a graph of the linked A-OALPs that define the behavior of the second set of temporally linked A-OALPs of FIG. 33, this time with multiple non-consecutive missing A-OALP elements, in accordance with embodiments of the present invention.

FIG. 36 shows two diagrams, each showing how to generate a source values table to define an A-OALP missing from a chain of linked A-OALPs, in accordance with embodiments of the present invention.

FIG. 37 shows a graph of a set of linked A-OALPs with every other linked A-OALP missing and shows their associated set of source values tables, defining a 2:1 A-OALP-level compression ratio, in accordance with embodiments of the present invention.

FIG. 38 shows the conversion of compressed linked A-OALPs into linearized form such that other loss-less compression methods, like ZIP or GNU can be used, bringing the total linked A-OALP compression ratio up to a 4:1 A-OALP-level compression, in accordance with embodiments of the present invention.

FIG. 39 shows that adjacent blocks of A-OALPs can be compressed and recovered using the endpoint A-OALPs, in accordance with embodiments of the present invention.

FIG. 40 shows that with advanced output, all of the linked A-OALPs can be compressed and recovered without endpoint A-OALPs, called herein supercompression, which is shown to lead to secure execution, in accordance with embodiments of the present invention.

FIG. 41 shows the standard operating system (OS) software execution layers compared to the OS-less A-OALP execution system layers, in accordance with embodiments of the present invention.

FIG. 42 shows the process flow for a distributed adaptive cooperative scheduler (DACS), in accordance with embodiments of the present invention.

### DETAILED DESCRIPTION

The present invention completes the description of various ambiguities that are a logical result of Alan Turing's and Alonzo Church's formalization of algorithms and computation. These ambiguities include: Turing's Second Temporal Ambiguity (loops containing non-loop control conditions), Turing's Third Temporal Ambiguity (variable value changes within a looping structure affecting the number of loop iterations), Turing's First Spatial Ambiguity (loops containing non-loop control conditions that vary memory allocation), Turing's Second Spatial Ambiguity (loops containing non-loop control conditions that affect memory allocation, which in turn affects the number of loop iterations), Turing's Third Spatial Ambiguity (loops containing memory allocation that directly affect loop iterations), Turing's First Output Ambiguity (loops containing non-loop control conditions that change based on input values and affect the output variable value), Turing's Second Output Ambiguity (determination of a non-loop control condition value within a looping structure coming from the calculation of one or more components of the output variable), and Turing's Third Output Ambiguity (the calculation of a component of the output variable within a loop that changes the number of loop iterations).

New details are provided on the impacts of using output-affecting linear pathways (A-OALPs) as the nodes of neural networks. This includes using the context-aware, reversible parallel A-OALP processing framework to define objects and their behavior and compute appropriate responses to the object's predicted behaviors. Linked A-OALPs over time (called herein, object behavior or just behavior) is shown to be useful in solving the vanishing gradient problems of recurrent neural networks, recursive cascade correlation neural networks, and recursive neural tensor networks.

A new model of software scheduling is provided. Rather than a central system managing the allocation of the software code's use of servers, processors, cores, and memory, herein distributed adaptive cooperative schedulers (DACSs) are defined. Each lowest-level DACS is shown to interact with a server's resource checker to locally manage A-OALP selection as well as perform processor, core and memory allocation. Since A-OALPs with DACS can allocate and de-allocate all required system resources as well as determine the algorithms to be executed, and since safe execution removes external attack surfaces, there is no longer a need for an operating system (OS). This concept is called OS-less execution.

A-OALP-based encryption is extended by using multiple linked A-OALPs to encrypt and using the associated reverse A-OALPs to perform decryption. The concept of compression is also extended into the new concept of supercompression, which is used to define a form of linked A-OALP execution herein called secure execution. In secure execution, only the currently executing A-OALP in the linked A-OALPs is decompressed while all other A-OALPs in the composed list of A-OALPs remain compressed, greatly decreasing program memory requirements. The concept of supercompression is extended to include neural networks and time series neural networks.

All patent applications, publications, and patents, and their corresponding disclosures and details, referenced or identified herein are hereby fully incorporated herein by reference.

Various devices or computing systems can be included and adapted to process and carry out the aspects, computations, and algorithmic processing represented by the software systems and devices of the present invention may include a processor, which may include one or more microprocessors and/or one or more circuits, such as an Application Specific Integrated Circuit (ASIC), Field-Programmable Gate Arrays (FPGAs), Central Processing Units (CPUs), Graphical Processing Units (GPUs), General-Purpose Computing on Graphics Processing Units (GPGPUs), Tensor Processing Units (TPUs), Floating-Point Units (FPUs), single-core, multicore, etc. Further, the devices can include a network interface. The network interface is configured to enable communication with a communication network, other devices and systems, and servers, using a wired and/or wireless and/or quantum connection.

The devices or computing systems may include memory, such as non-transitive, which may include one or more non-volatile storage devices and/or one or more volatile storage devices (e.g., random access memory (RAM) or Qubits. In instances where the computing devices include a microprocessor, computer readable program code may be stored in a computer readable medium or memory, such as, but not limited to drive media (e.g., a hard disk or SSD), optical media (e.g., an OVO), memory devices (e.g., random access memory, flash memory, Qubits), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, subroutines, and modules may be implemented in software, in firmware, in special purpose digital logic, and any combination thereof without deviating from the spirit and scope of the present invention as recited within the claims attached hereto.

The devices or computing devices may include an input device. The input devices are configured to receive an input from either a user (e.g., admin, user, etc.) or a hardware or software component—as disclosed herein in connection with the various user interface or automatic data inputs. Examples of an input device include a keyboard, mouse, microphone, touch screen and software enabling interaction with a touch screen, etc. The devices can also include an output device. Examples of output devices include monitors, televisions, mobile devices screens, tablet screens, speakers, remote screens, etc. The output devices can be configured to display images, media files, text, video or play audio to a user through speaker output.

Server processing systems for use or connected with the systems of the present invention, can include one or more microprocessors, and/or one or more circuits, such as an application specific integrated circuits, such as an application specific integrated circuit (ASIC), field-programmable gate arrays (FPGAs), qubit arrays etc. A network interface can be configured to enable communication with a communication network, using a wired and/or wireless connection, including communication with devices or computing devices disclosed herein. Memory can include one or more non-volatile storage devices and/or one or more volatile storage devices (e.g., random access memory (RAM)). In instances where the server system includes a microprocessor, computer readable program code may be stored in a computer readable program code may be stored in a computer readable medium, such as, but not limited to drive media (e.g., a hard disk or SSD), optical media (e.g., a DVD), memory devices, etc.

Throughout the present disclosure, “core,” “cores,” “processing element,” and “processing elements” can be interchangeable. Further, a core or processing element can comprise one or more distinct cores or processing elements.

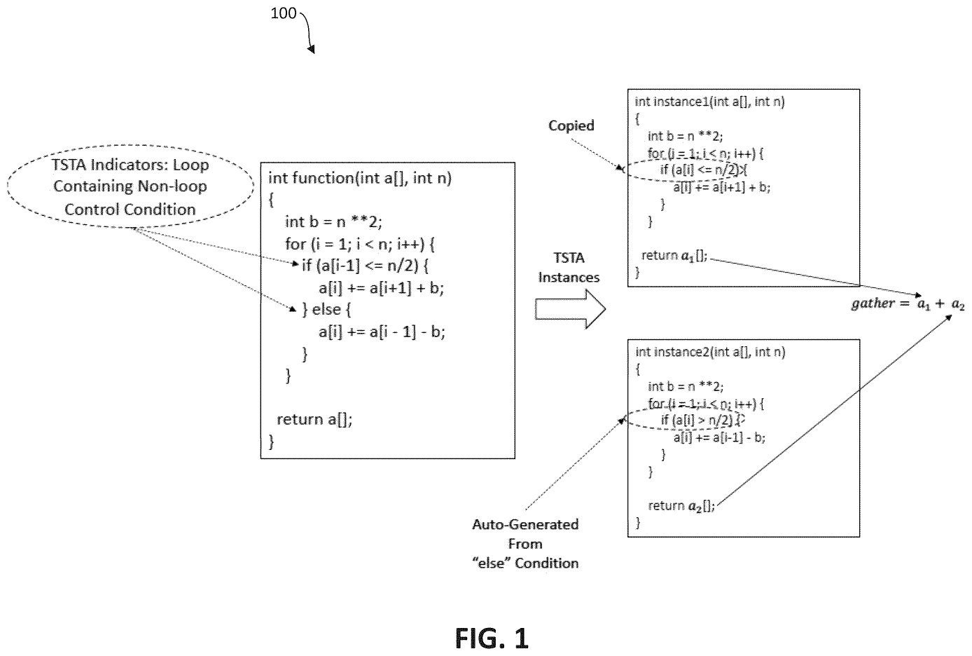

FIG. 1 shows an example 100 of a C programming language source code whereby the processing time changes from one loop iteration to the next because there is a non-loop control condition that varies which processing pathway within a loop is traversed. This condition is called Turing's second temporal ambiguity, TSTA. In order to overcome this ambiguity, unlike in the art, here the non-loop control condition is decomposed and split across multiple parallel instances. This means that the processing time of each parallel instance becomes deterministic and predictable, with the longest processing time defining the TSTA processing time. Once complete, the output values of all instances are combined using the gather function, which depends on the relationship between the instances.

$$\begin{matrix}{Turing}^{′} s Second Temporal Ambiguity Processing Time & \\ t \times units = max ( {T}_{{instance}_{1}} ( \vec{a} ) , {T}_{{instance}_{2}} ( \vec{a} ) , ... , {T}_{{instance}_{n}} ( \vec{a} ) ) \times units & Equation 1\end{matrix}$$

$$Where max ( ) = maximum value function ,$$

$${T}_{x} ( \vec{a} ) = advanced time complexity of instance x ,$$

$$n = number of TSTA instances ,$$

$$\vec{a} = input variable attributes that affect loop iterations ,$$

$$units = processing time unit ( ns , μ s , ms , cs , ds , s ) .$$

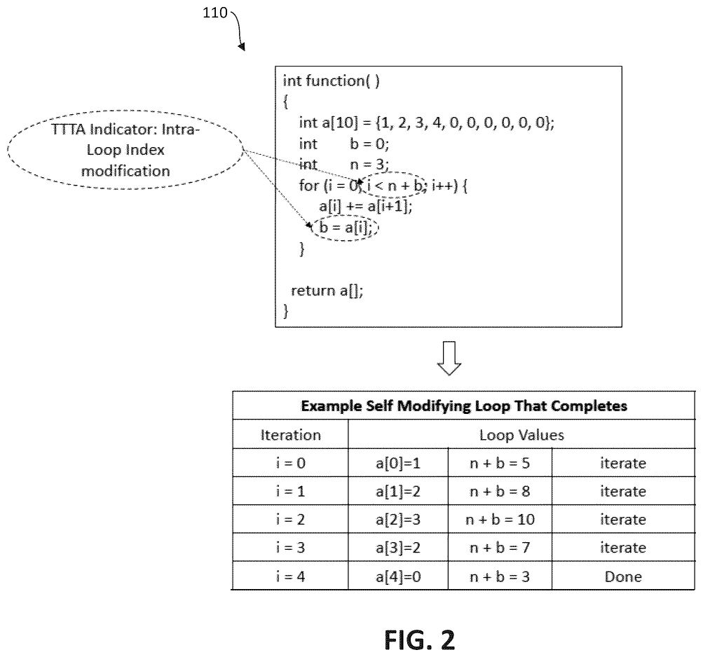

FIG. 2 shows an example 110 of a C programming language source code whereby the number of loop iterations is modified by the calculations driven by at least one variable within the looping structure. This is Turing's third temporal ambiguity, TTTA. The source code values that modify time from the number of loop iterations are shown in a table of loop iterations. With each iteration, the value of an internal variable is changed, and that changed value is used as part of the ending condition of the loop itself. Once the ending condition is met, the looping stops. The processing time is calculated as a function of the internal variable value required to halt the loop, meaning the TTTA condition is no longer ambiguous. If there is no possibility of calculating an internal loop variable value that meets the loop ending condition, then the execution pathway containing that loop is not considered an A-OALP.

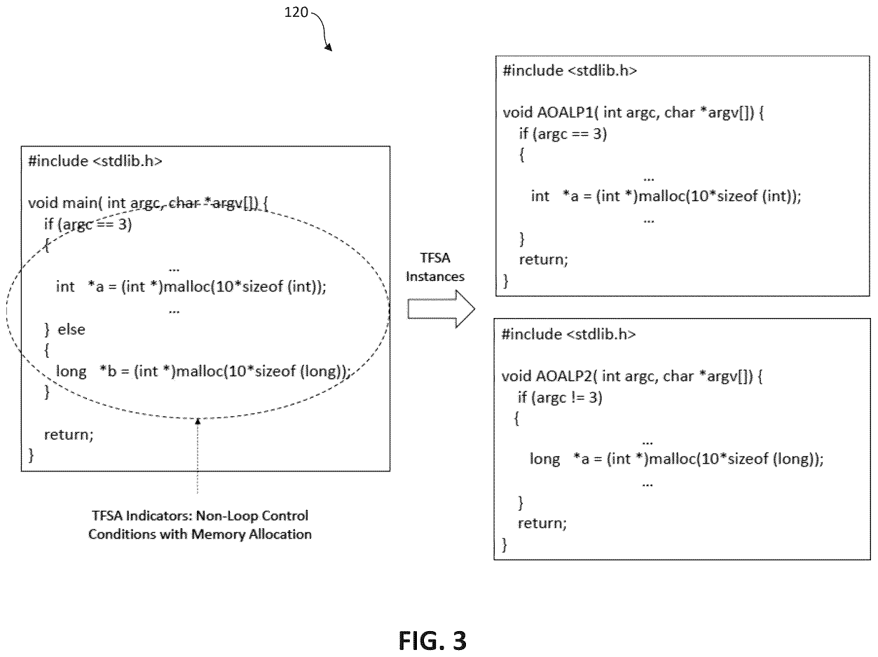

FIG. 3 shows an example 120 of a C programming language source code that indicates Turing's first spatial ambiguity, TFSA. TFSA comes from the fact that the execution pathway is unknown until execution because the non-loop control conditions are unknown until they are executed. Execution of the non-loop control conditions redirect the process flow of an algorithm, giving ambiguity to the memory allocation. This ambiguity is directly addressed using A-OALP decomposition because, as shown in U.S. Pat. No. 12,411,671, the A-OALP execution pathway is selected prior to its execution.

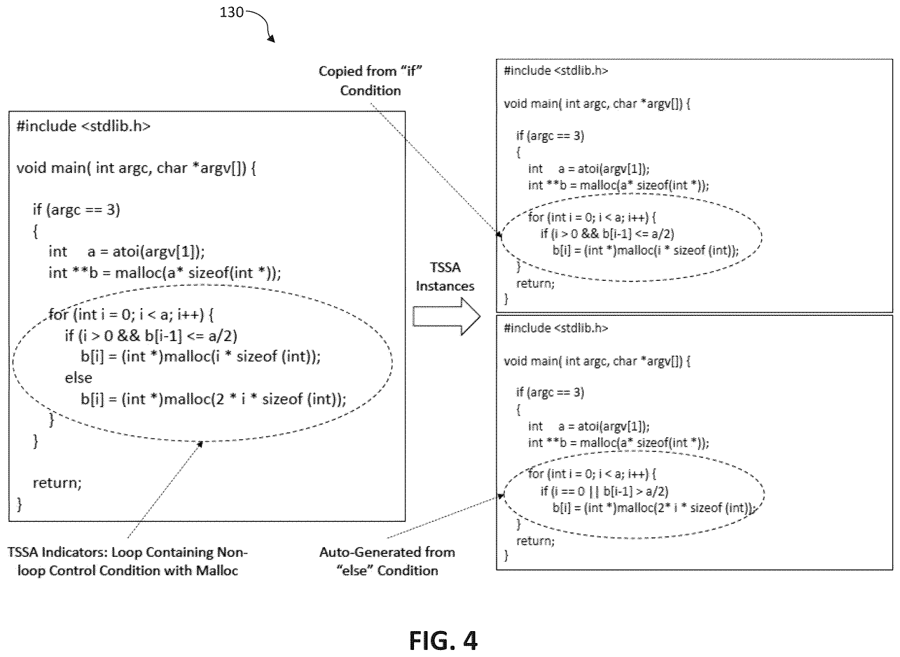

FIG. 4 shows an example 130 of a C programming language source code whereby the memory allocation changes from one loop iteration to the next because there is a non-loop control condition that varies which processing pathway within a loop is traversed. This condition is called Turing's second spatial ambiguity, TSSA. In order to overcome this ambiguity, the non-loop control condition within a loop is decomposed and split across multiple parallel instances. This means that the memory allocation of each instance becomes deterministic and predictable, with the sum of the memory allocations of each parallel instance defining the TSSA memory allocation. There is a maximum amount of memory allocation for each instance and for the sum of the memory allocation. If the calculated size exceeds the memory available, then the A-OALP cannot execute.

$$Turing ’ s Second Spatial Ambiguity Memory Allocation$$

$$m \times units = ( \text{?} ( \vec{b} ) + \text{?} ( \vec{b} ) + … + \text{?} ( \vec{b} ) ) \times units \qquad Equation 2$$

$$Where max ( ) = maximum value function ,$$

$$\text{?} ( \vec{b} ) = advanced space complexity of instance x ,$$

$$n = number of TSSA instances ,$$

$$\vec{b} = input variable attributes that affect memory allocation ,$$

$$units = memory units ( bits , bytes , kB , mB , etc . ) .$$

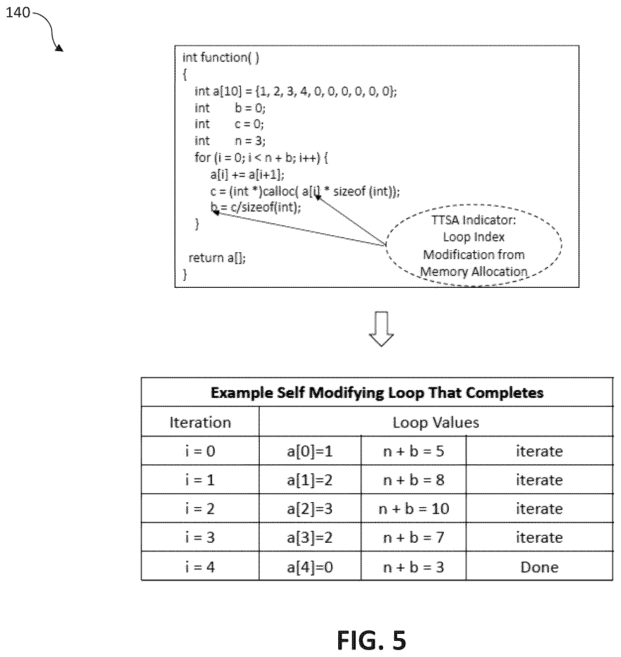

FIG. 5 shows an example 140 of a C programming language source code whereby the number of loop iterations is modified by the memory allocation within the looping structure. This is Turing's third spatial ambiguity, TTSA. The source code values that modify memory allocation from the number of loop iterations are shown in a table of loop iterations. With each iteration, the value of an internal variable is changed, and that changed value is used as part of the ending condition of the loop itself. Once the ending condition is met, the looping stops. The memory allocation is calculated as a function of the internal variable value required to halt the loop. If there is no possibility of calculating an internal loop variable value that meets the loop ending condition, then the pathway of that loop is not considered an A-OALP.

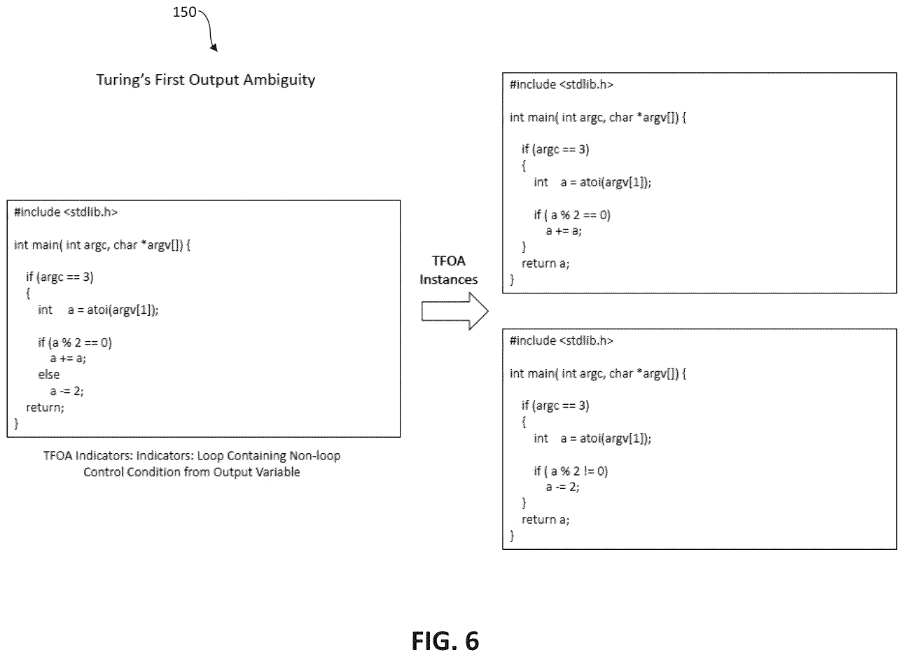

FIG. 6 shows an example 150 of a C programming language source code that indicates Turing's first output ambiguity, TFOA. TFOA comes from the fact that the execution pathway is unknown until execution because the non-loop control conditions are unknown until they are executed. Execution of the non-loop control conditions redirect the process flow of an algorithm, giving ambiguity to the output. This ambiguity is directly addressed using A-OALP decomposition because, as shown in U.S. Pat. No. 12,411,671, the A-OALP execution pathway is selected prior to its execution.

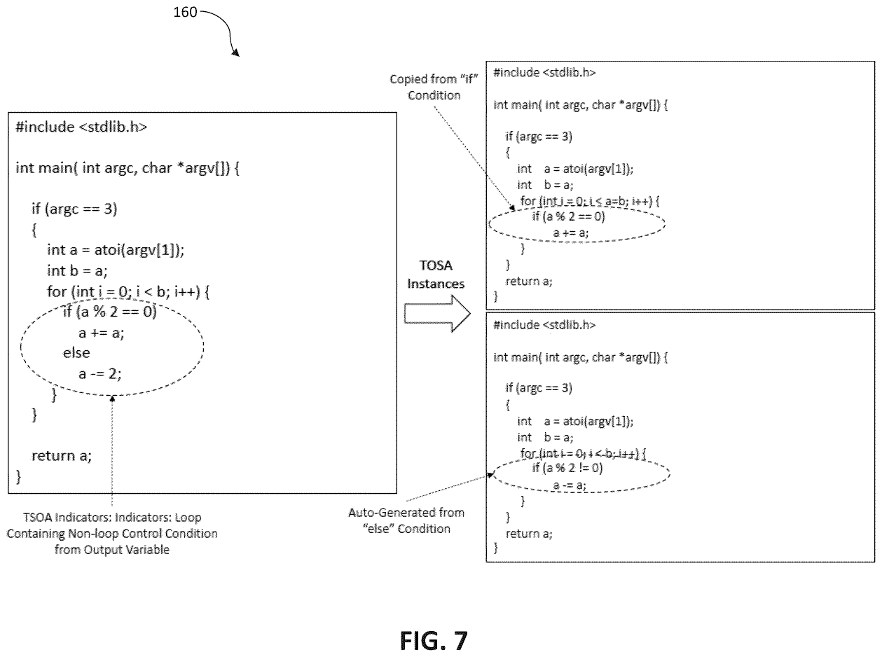

FIG. 7 shows an example 160 of a C programming language source code whereby the output values change from one loop iteration to the next because there is a non-loop control condition that varies which processing pathway within a loop is traversed. This condition is called Turing's second output ambiguity, TSOA. In order to overcome this ambiguity, the non-loop control condition within a loop is decomposed and split across multiple parallel instances. This means that the output of each instance becomes deterministic and predictable, with the sum of the output values of each parallel instance defining the TSOA output.

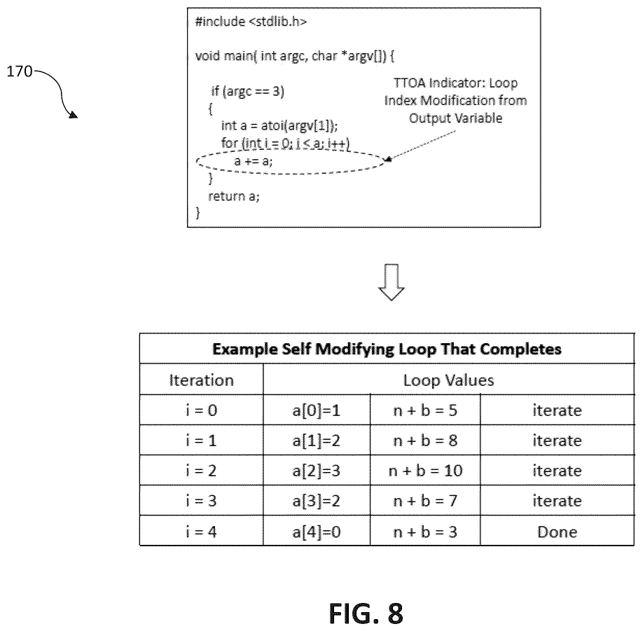

FIG. 8 shows an example 170 of a C programming language source code whereby the number of loop iterations is modified by the intermediate values within the looping structure. This is Turing's third output ambiguity, TTOA. The source code values that modify the intermediate values from the number of loop iterations are shown in a table of loop iterations. With each iteration, the value of an internal variable is changed, and that changed value is used as part of the ending condition of the loop itself. Once the ending condition is met, the looping stops. The output is calculated as a function of the internal variable value required to halt the loop. If there is no possibility of calculating an internal loop variable value that meets the loop ending condition, then the pathway of that loop is not considered an A-OALP.

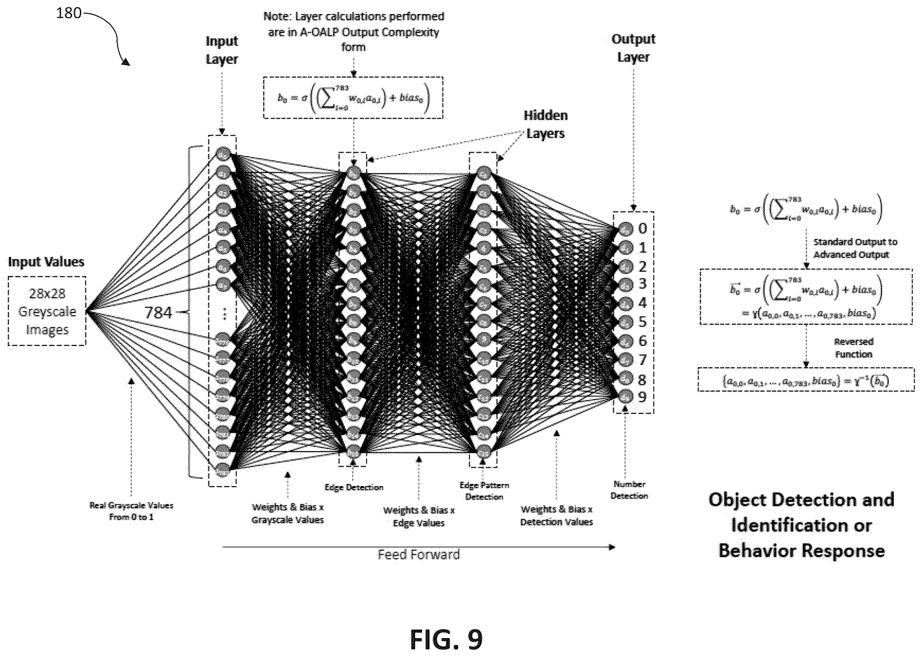

Referring to FIG. 9 through FIG. 11, A-OALPs are shown to replace nodes in neural networks, increasing the amount of parallelism found in the network and allowing for the incorporation of the advanced output of the aforementioned technology to ensure network reversibility.

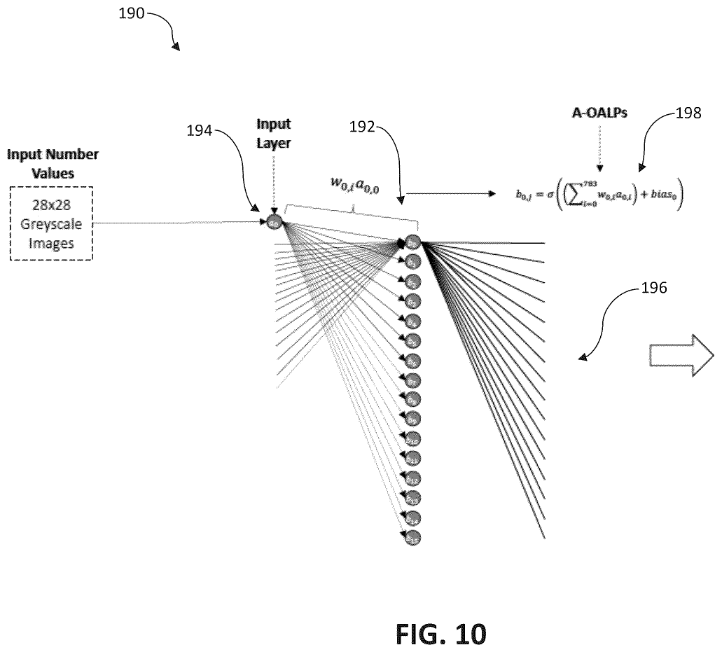

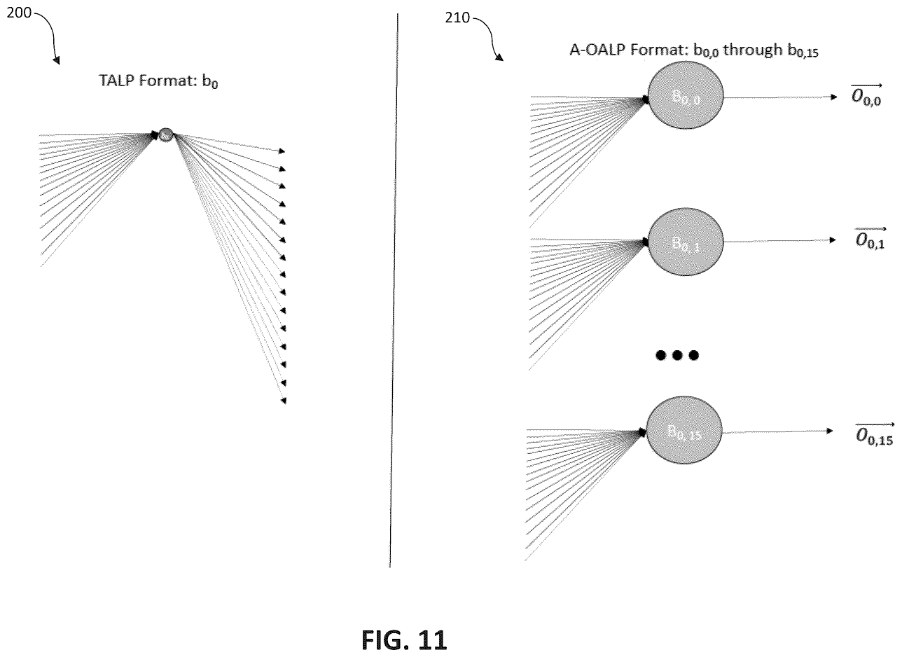

FIG. 9 is a diagram 180 showing a neural network used to detect and identify either an object or an object's behavior. Changes in the detected object's attributes over time represent that object's behavior. The observed and predicted interactions between the detected object's behavior and changes to the current system's output attributes generate the system's response to the object's behavior. As detailed in FIG. 10, each node in each layer in the neural network can receive multiple input values and generate multiple output values. It is further detailed in FIG. 11 that such an arrangement can be defined as a TALP or as multiple A-OALPs. When defined as multiple A-OALPs, each node of each layer can generate advanced outputs, meaning that they are reversible.

FIG. 10 is a diagram 190 showing a portion of the neural network of FIG. 9, highlighting the first node of the second layer 192. Shown is the transmission of the weighting factor multiplied by the value of the first node of the input layer 194. Each node of the second layer 192 receives output from every node in the first layer 194 and generates multiple output transformations 196, each of which is shown to be an A-OALP 198. Note that each layer has a separate structure.

FIG. 11 shows two diagrams 200, 210 depicting different views of the same neural network node. The first diagram 200, the time-affecting linear pathway or TALP view, shows an example node in an example neural network as a transformation of multiple inputs into a set of unreversible multiple outputs. Each standard neural network node can be represented as a TALP. The second diagram 210, the advanced output-affecting linear pathway or A-OALP view, shows the same example node depicted as a set of parallel A-OALPs, each of which has multiple inputs and a single advanced output. The advanced output vector, which includes the input variable values and the output variable value, enables the single output to be reversible. Thus, the A-OALP is inherently parallel (one parallel instance per neural network node output variable) and inherently reversible.

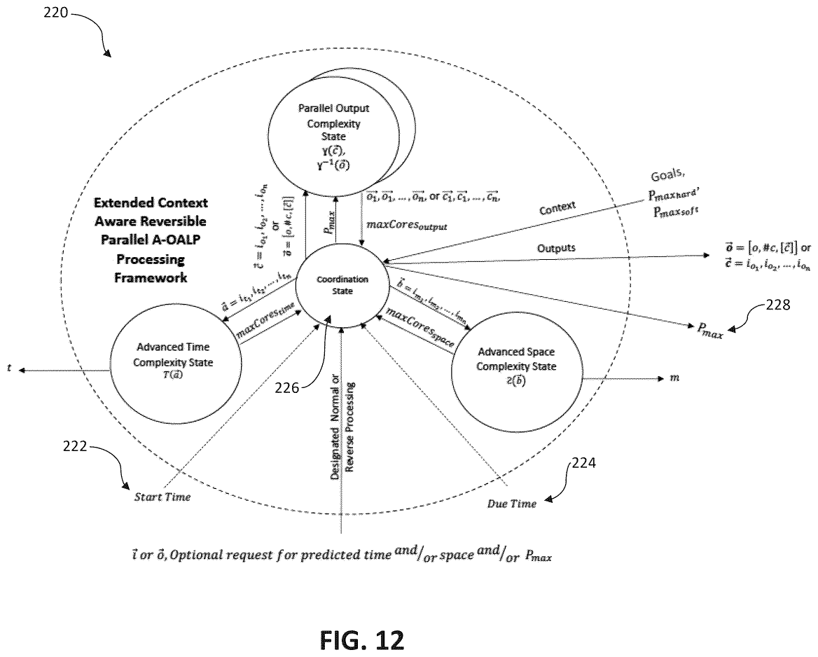

FIG. 12 shows a diagram 220 that extends the context-aware reversible parallel A-OALP processing framework. The addition of start time 222 and due time 224 determines the maximum number of instances required by the framework to perform its transformation within the scheduled time. This is accomplished by calculating maxCoresₜᵢₘₑ, maxCores_{space}, and maxCoresₒᵤₜₚᵤₜ within the coordination state 226 rather than within the advanced time complexity, advanced space complexity, or output complexity states. This centralizes the framework's processing core count and allows for accessing the resultant Pₘₐₓ value 228 through the coordination state. The minimum value of speedup, freeup, and divvyup for a given input dataset determines the number of cores that can be used for that A-OALP executing the current input dataset on the current hardware system, Pₘₐₓ 228.

$$A - OALP Coordination State Calculation$$

$${P}_{max} = min ( \frac{\vec{a}}{{a}_{min}} , \frac{\vec{b}}{{b}_{min}} , \frac{\vec{c}}{{c}_{min}} , {P}_{{max}_{hard}} , {P}_{{max}_{soft}} ) \qquad Equation 3$$

$$Where : \vec{a} = input variables that affect loop iterations ( variable time ) ,$$

$${a}_{min} = minimum possible valid temporal input variable value for the A - OALP ,$$

$$\vec{b} = input variables that affect memory allocation ,$$

$${b}_{min} = minimum possible valid spatial input variable value for the A - OALP ,$$

$$\vec{c} = input variables that affect output variable value of the A - OALP ,$$

$$possible valid input variable value that affects the output value of the A - OALP ,$$

$$\frac{\vec{a}}{{a}_{min}} = advanced speedup , \frac{\vec{b}}{{b}_{min}} = freeup , \frac{\vec{c}}{{c}_{min}} = divvyup ,$$

$${P}_{{msx}_{hard}} = number of available processing elements ,$$

$${P}_{{max}_{soft}} = user - defined limit to available processing elements .$$

It is now possible to calculate constrained processing time, which is the processing time given Pₘₐₓ 228, and the constrained memory allocation given Pₘₐₓ 228. This gives the following predictive equations.

$$Constrained Processing Time for A - OALP$$

$$t \times {units}_{time} = T ( {P}_{max} ) \times {units}_{time} \qquad Equation 4$$

$$Where : {units}_{time} = time units ( ns , ms , s , etc . ) .$$

$$Equation 5 Constrained Memory Allocation for A - OALP$$

$$\text{?} \times {units}_{space} = \text{?} ( {P}_{max} ) \times {units}_{space}$$

Where: units_{space}=spatial units (bits, bytes, words, etc.)

Consider the concept of A-OALP-based space complexity. Unlike time complexity or output complexity, which represent the result of transformations by the A-OALP, space complexity is instead the allocation of a particular resource (memory) to be used in the execution of an A-OALP. The maximum number of processing elements that can be used in the execution of an A-OALP is also a type of allocation. This means that the concept of “space” is actually the concept of resource allocation of any equipment required in the execution of an A-OALP. There are only two prerequisites: allocability from input variable values and assignable units for the resource.

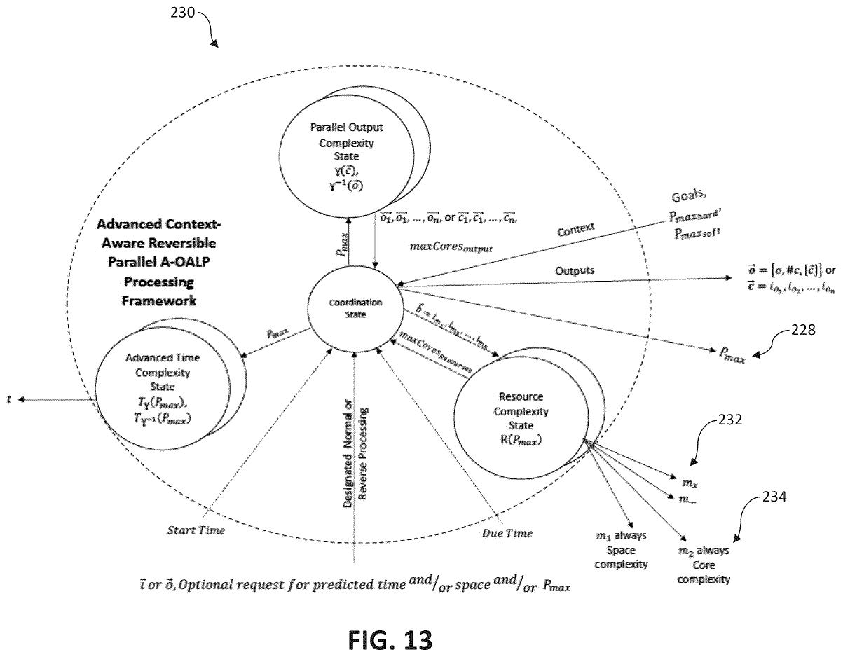

FIG. 13 diagrams the advanced context-aware reversible parallel A-OALP processing framework 230, one framework per A-OALP. This framework changes the space complexity state into a set of parallel resource complexity states 232. One of the resources must always be space complexity (memory allocation), which is shown as generating m₁, and one of the resources must always be the number of processing elements (cores) available, which is shown as generating m₂ 234. Each resource has its own set of input variable attribute values that are used to calculate the resource complexity. Including other resources means that logistics networks are included as A-OALP networks. Each resource can be calculated independently and therefore all resource complexity values can be executed in parallel, which is a type of task parallelism. Like parallel output complexity instances, all of which contain the same amount of work for a given job, the parallel instances of each resource complexity do the same amount of work. However, the different resource complexities themselves can be run in parallel. This changes the A-OALP coordination state calculation to the following:

$$Advanced A - OALP Coordination State Calculation$$

$$Equation 6$$

$${P}_{max} = min ( \frac{\vec{a}}{{a}_{min}} , ( \frac{\vec{{b}_{1}}}{{b}_{{1}_{min}}} , \frac{\vec{{b}_{2}}}{{b}_{{2}_{min}}} , … , \frac{\vec{{b}_{x}}}{{b}_{{x}_{min}}} ) , \frac{\vec{c}}{{c}_{min}} , {P}_{{max}_{hard}} , {P}_{{max}_{soft}} )$$

$$Where \vec{{b}_{1}} through \vec{{b}_{x}} = resource input variable values for A - OALP ,$$

$${b}_{{1}_{min}} through {b}_{{x}_{min}} = minimum valid input variable values for a given resource ,$$

$${P}_{{msx}_{hard}} = number of available processing elements ,$$

$${P}_{{max}_{soft}} = user - defined limit to available processing elements .$$

As with space complexity, the various resource complexities are generated by creating a set of source values tables, one per resource per A-OALP, and performing a curve fit on each strictly monotonic or constant, continuous, differentiable, single-valued data segment, which can be converted either into reversible form for execution on a two-way reversible logic computer or into plane waves for execution on one-way quantum computing, that is, measurement-based quantum circuits as was shown in advanced space complexity. The networks of resource states from linked A-OALPs can be compressed like any other A-OALP analytic.

Consider that advanced time complexity is the curve fit of the processing time of an A-OALP given an input dataset and the constraints on the number of usable processing elements. Since the A-OALP is reversible and since reversing the A-OALP processing can take different processing times from its forward processing time, a separate advanced time complexity for the reverse A-OALP processing is required. The forward and reverse advanced time complexities are depicted in this framework.

Both the extended and advanced context-aware reversible parallel A-OALP processing frameworks are shown accepting an expected externally defined (external to the A-OALP framework) start time, which is the beginning of the A-OALP's processing time after the last input variable's value is received, and an expected externally defined (external to the A-OALP framework) due time when an A-OALP is expected to complete. Adding the start time to the t=T_{y}(Pₘₐₓ)—derived predicted processing time for all A-OALPs used to provide input to a common next linked A-OALP gives the soonest time when the next linked A-OALP can activate. The next activation is given as the maximum processing time plus start times of all input-generating A-OALPs. That is, if the input-generating A-OALPs are: tₚᵣᵢₒᵣ_{₁}, tₚᵣᵢₒᵣ_{₂}, . . . , tₚᵣᵢₒᵣ_{ₓ} then we get the following:

$$Predicted Succeeding A - OALP Execution Starting Time$$

$${t}_{next A - OALP} = max ( {t}_{{prior}_{1}} , {t}_{{prior}_{2}} , … , {t}_{{prior}_{x}} ) \qquad Equation 7$$

$$Where :$$

$${t}_{{prior}_{1}} , {t}_{{prior}_{2}} , … , {t}_{{prior}_{x}} = predicted completion time of prior A - OALPs ( 1 through x )$$

With various methods, the ability of surge processing to meet a deadline is difficult to explicitly model. An A-OALPs' ability to dynamically manage multiple processing instances through the Pₘₐₓ 228 calculation and the inclusion of hard and soft limits to that calculation makes it easy to manage surge capability. For example, if the time due for an A-OALP is achievable using a single processing element then that one processing element's processing time represents the standard non-surge performance requirement. If that processing time plus the actual start time predicts a completion time after the due time, then rather than the standard model of slipping a schedule (which is not possible for most real-time requirements), the system determines from the Pₘₐₓ 228 how late the start time could be before the schedule is impacted. If the predicted time is after the scheduled start time, unused resource capacity can be used to make up for time lost by the preceding linked A-OALPs. This allows the entire system to automatically participate in meeting real-time requirements. Since late events can be made up with increased processing, slack within the chain of processing logic can be expressly eliminated without risk.

Unlike other A-OALP frameworks, the advanced context-aware reversible parallel A-OALP processing framework can also use available energy as a resource. Consider that energy is calculated as power multiplied by time, meaning that combining the advanced time complexity curve fit with a power use per core curve gives the energy complexity; that is, for a given A-OALP executing on a given hardware system with a given input dataset, since processing time is a function of core count, the energy used is a function of the core count used in execution. The inverse is that given an energy value, the number of cores required for execution can be generated for some given A-OALP executing on a given hardware system with a given input dataset. This means that energy use can be guaranteed using this framework. Thus, the relationship between power grid service level agreements and energy use can be managed using an A-OALP-based system.

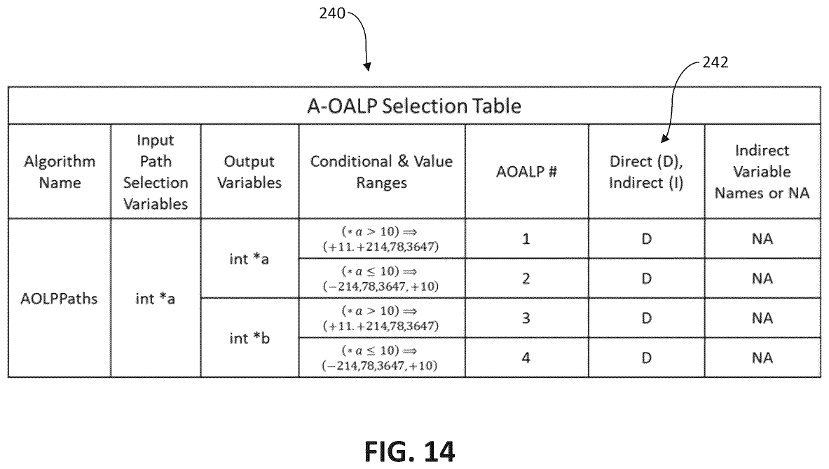

FIG. 14 shows a table 240 used to directly select an A-OALP given some set of input variables. This means that the receipt of an input dataset is enough to dynamically schedule the execution of an A-OALP such that processing time, energy use, memory allocation, and other goals, can be taken into consideration. Both direct and indirect input variables 242 are used in the selection process. An indirect input variable is a variable that is connected to a direct input variable via some calculation.

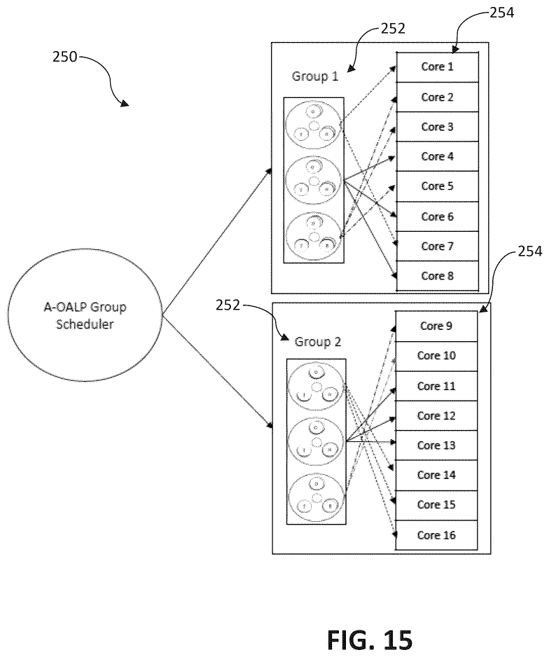

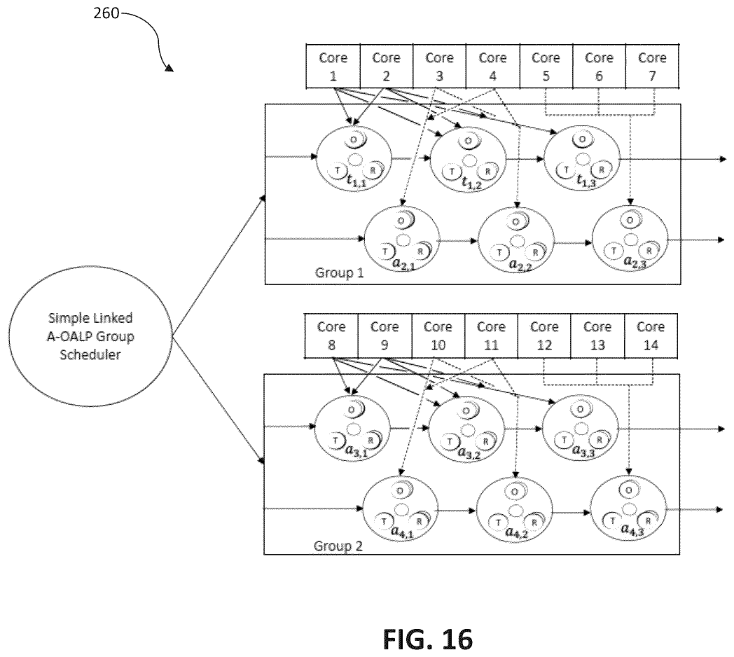

In reference to FIG. 15 and FIG. 16, a simplified view of a new concept in network scheduling, herein called the distributed adaptive cooperative scheduler (DACS), is shown. As discussed above, standard schedulers have central control that can lead to bottlenecks. Consider that each A-OALP separately calculates its processing time, memory allocation, and number of processing elements and that this information can be computed prior to the execution of the A-OALP or set of linked A-OALPs, meaning that processing behaviors can be precisely calculated. This calculated processing behavior can be used in a new kind of scheduler, one based on deterministic behaviors, not on statistics or heuristics. DACS-based scheduling can take into consideration energy, performance, and resource use envelopes that directly link external context (like energy availability, etc.) to resource allocation at the server level.

FIG. 15 shows a diagram 250 that relates the scheduling of groups of A-OALPs 252 to groups of processing elements (cores) 254. Each A-OALP in a group allocates its own set of processing elements. Unlike centralized schedulers that require the scheduler to allocate the resources required for each software element (that is, each concurrently executing application), the DACS system schedules groups of concurrently executing software elements (A-OALPs), and each software element in the group schedules its own resources.

FIG. 16 shows a diagram 260 expanding the group scheduling concept to include linked A-OALPs; that is, the concept of group scheduling is expanded to network scheduling.

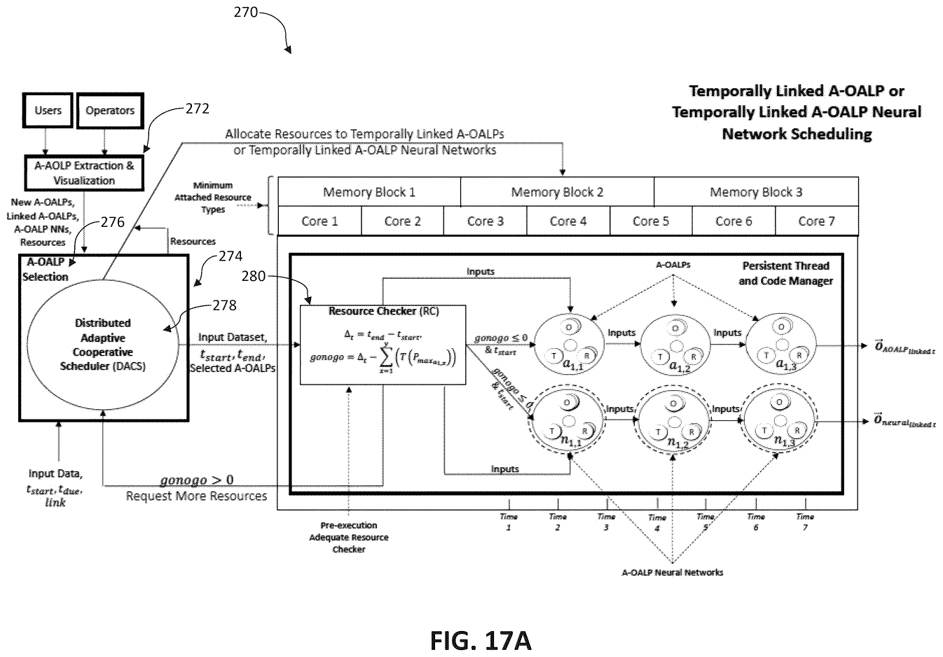

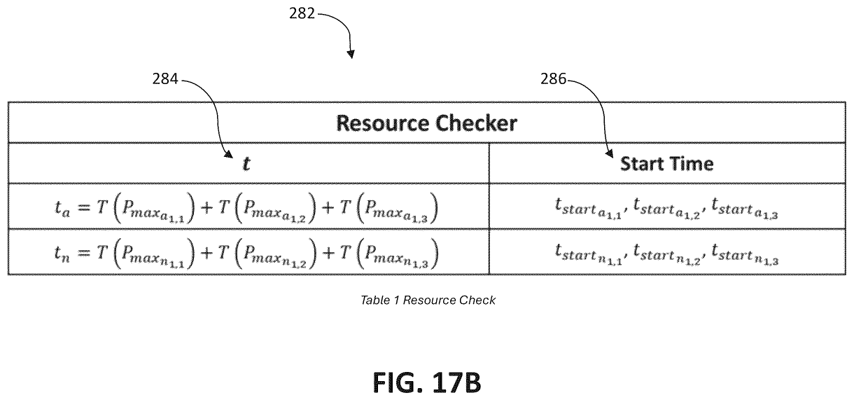

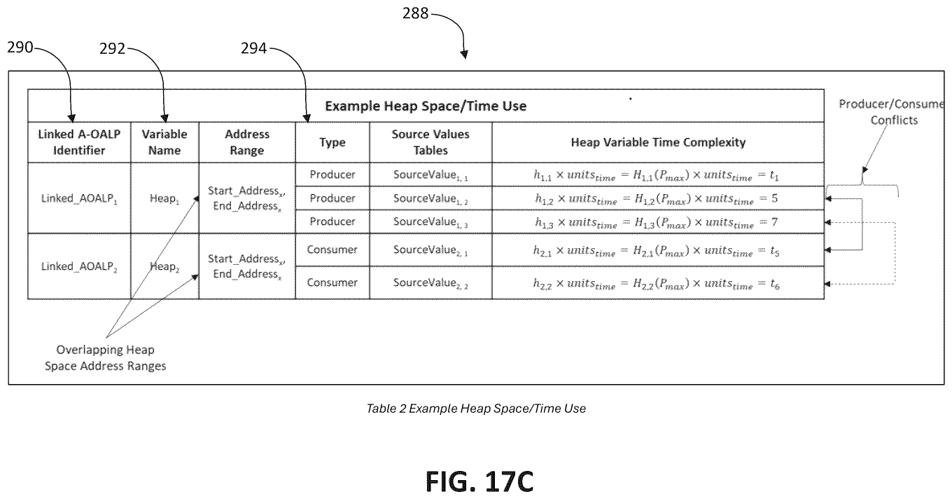

FIG. 17A shows a diagram 270 of two primary software structures used to manage A-OALP execution: A-OALP extraction and visualization 272 and A-OALP server-hardware-controller 274. The A-OALP extraction and visualization structure 272 attaches A-OALP frameworks to a set of persistent processing threads, one A-OALP framework per thread. Within the A-OALP server-hardware-controller 274 of other methods, there is a software component called A-OALP selection.

The current invention expands the A-OALP selection component 276 by adding a subcomponent called the distributed adaptive cooperative scheduler (DACS) 278. The DACS subcomponent can receive real-time requirements in the form of an expected start time, tₛₜₐᵣₜ and an expected due time, t_{due}, along with a set of input data. The input data values are used to select an A-OALP. However, if the selected A-OALP is the first A-OALP of a list of linked A-OALPs and the use linked flag is set, link>0, then a list of linked A-OALPs is accessed. If the use linked flag is reset, link≤0, the unlinked A-OALP is selected. The starting and ending processing times along with the input dataset are then transferred to the selected A-OALP (or lead A-OALP in the case of linked A-OALPs). Herein each A-OALP is associated with a resource checker 280, one per server. Instead of the rigid detailed resource allocation and job start control of a traditional scheduler, the present invention splits scheduling duties between the DACS 278 and a resource checker 280. The resource checker 280 first calculates the given processing time span, Δt. Next, the go/no-go signal is calculated by determining the predicted processing time given serially linked A-OALPs,

$$t = {\sum }_{x = 1}^{y} ( T ( {P}_{{max}_{{a}_{1 , x}}} ) ) ,$$

and then calculating the go/no-go signal gonogo=(Δt−t). If (gonogo>0) then more resources are required to meet the timing goal. If (gonogo≤0) then at tₛₜₐᵣₜ, the lead A-OALP will begin processing its data.

A-OALP neural networks behave similarly to linked A-OALPs except networks are comprised of multiple associated sets of linked A-OALPs instead of a single linked list of A-OALPs, and the same concepts are applied. When the list of temporally linked A-OALPs or neural network A-OALPs is being constructed, all Pₘₐₓ curve fits for each A-OALP or A-OALP neural network are saved in a structure called the resource checker table 282, as shown in FIG. 17B. The table 282 allows for the calculation of the fastest possible processing time t 284 given a selected A-OALP or selected temporally linked A-OALPs or A-OALP neural networks and the input dataset. It also allows for the calculation of the predicted fastest start times 286 of all linked A-OALPs or A-OALP neural networks.

As is shown in FIG. 17A and the associated resource checker table 282 of FIG. 17B, it is possible for more than one A-OALP and/or selected linked A-OALPs and/or A-OALP neural networks to exist simultaneously. This allows scheduling to include dataset producer-consumer temporal ordering without locks, extending the temporal concept of time prediction with temporal reordering to both linked A-OALPs and linked A-OALP neural networks. The system can profile heap space allocation and use this profile in the construction of a heap space-time variable allocation table 288, as shown in FIG. 17C. The only heap space variables that are profiled are those that are in a production-consumption relationship that are between multiple A-OALPs or multiple linked A-OALPs or multiple A-OALPs neural networks or any combination thereof. These variables are called heap space-time variables.

The heap space-time use table 288 shows two sets of linked A-OALPs 290 contained within the same shared memory environment, with one heap space variable (Heap₁, Heap₂) 292 per set of linked A-OALPs. Even through the variable names are different and occur within different sets of linked A-OALPs, the address ranges of both variables overlap within that environment, meaning that the variables represent the same or overlapping memory space. Given the two sets of linked A-OALPs 290 contained within the same shared memory environment, with one producing heap space variable value changes and the other consuming those same value changes, a production-consumption relationship is detected. This relationship generates the heap space-time variable from the two heap space variables in the shared memory, extending the concept of over-subscription to both linked A-OALPs and linked A-OALP neural networks. The processing time leading up to the production value changes and the processing time leading up to the consumption are profiled and used to generate heap space-time production complexity and heap space-time consumption complexity.

$$Heap Space - Time Production or Consumption Complexity$$

$${h}_{x , y} \times {units}_{time} = {H}_{x , y} ( {P}_{max} ) \times {units}_{time} where \qquad Equation 8$$

$${h}_{x , y} = processing time to the {y}^{th} change of the {x}^{th} heap variable ,$$

$${units}_{time} = time units ( ns , ms , s , etc . ) ,$$

$${H}_{x , y} ( {P}_{max} ) = advanced speedup to predict processing time to the {y}^{th} change of the {x}^{th} heap variable ,$$

$${P}_{max} = maximum number valid processing elements ,$$

$${h}_{x , {y}_{min}} = minimum possible processing time for the {y}^{th} change of the {x}^{th} heap variable .$$

When comparing the heap space-time production complexity and the heap space-time consumption complexity within the shared memory, temporal conflicts can be detected. Referring to table 288, a temporal conflict occurs between H_{1,2} and H_{2,1} and another between H_{1,3} and H_{2,3}. Rather than setting up locks, the system of the present invention increases the processing element count (when possible) of the producers prior to the potential consumption, thereby ensuring production before consumption, as shown at table component 294. If the core count is insufficient, then the start time of the consumption is delayed, ensuring a proper production-consumption relationship.

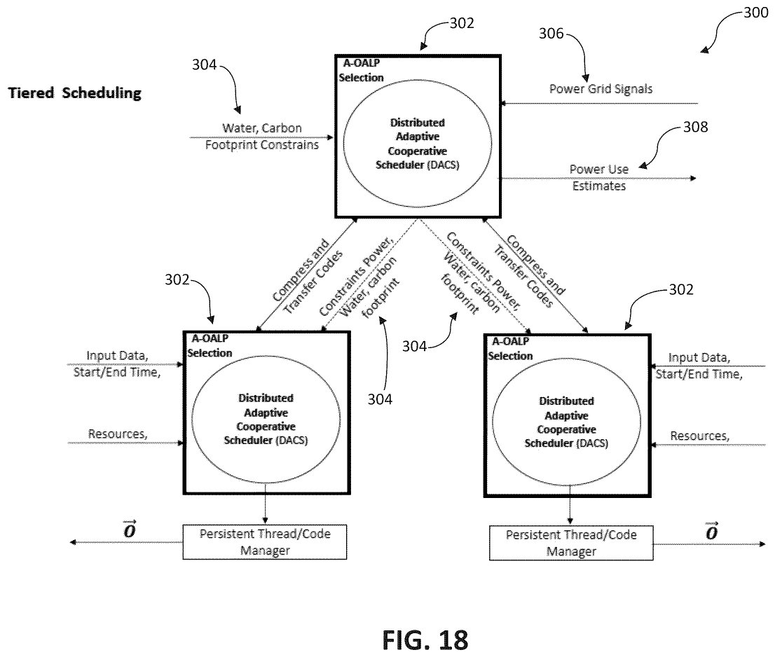

FIG. 18 is a diagram 300 showing an example of a multi-tiered DACS system 302. Here, goals (water use, carbon footprint, and power use) 304 are shared among different geographically dispersed locations where they are eventually used to manage the resources of any associated A-OALPs, linked A-OALPs, or A-OALP neural networks. Also shown is the transfer of compressed A-OALPs (codes) using the same multi-tiered DACS 302. Power grid signals 306 are automatically converted into goals, and power use estimates 308 are automatically gathered from geographically distributed A-OALPs and shared with the power grid.

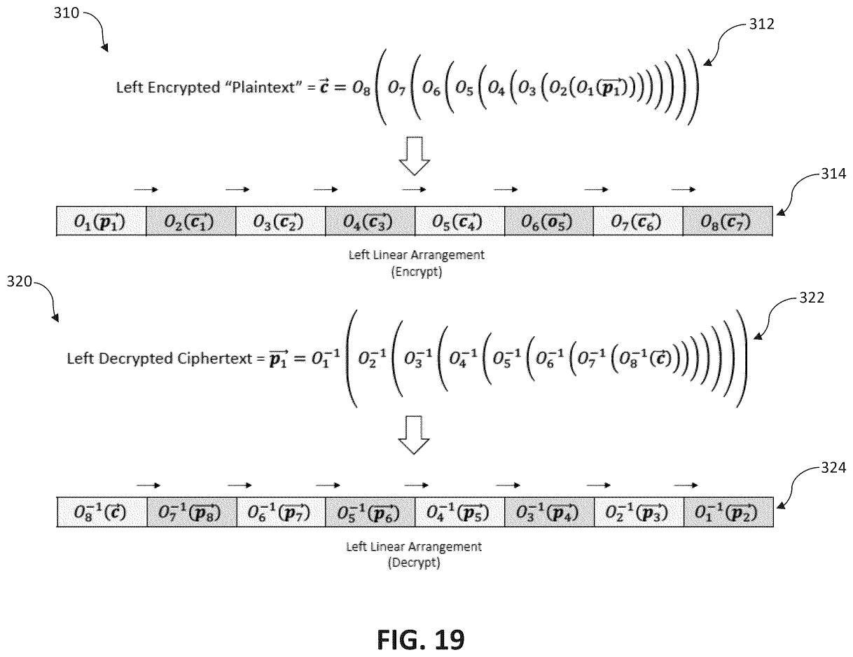

Referring to FIG. 19 through FIG. 29, a new type of encryption is proposed: algorithmic encryption. Various encryption methods are oriented to obscuring datasets, including images, text, and sets of numbers. Herein, algorithms or data transformations are instead encrypted. Algorithms are decomposed into A-OALPs, each having a single output. Each A-OALP that has a single input as well is always reversible. These traits mean that any set of linked single input A-OALPs can be used to encrypt and decrypt a software code.

Unlike traditional encryption methods, such as Data Encryption Standard, Advanced Encryption Standard, or other block-cipher families that depend on a fixed mathematical relationship between a plaintext, a ciphertext, and a key, the A-OALP-based algorithmic encryption model breaks this key dependency by using linked single input A-OALPs to encrypt and inverse linked single input A-OALPs to decrypt. Plaintext that is not already represented by a transformation is converted into a set of A-OALPs, first by associating input values like position with output values like the plaintext value itself then creating a source values table from the input/output pairs. The monotonic segments of these input-output pairs are used in a curve-fitting model to generate output complexities that are equivalent to A-OALPs. Alternatively, algorithms are decomposed into A-OALPs, exposing their source values table values.

The source values table data is the “plaintext” to be encrypted and can be multidimensionally folded and each dimension permuted. The folded permutated source values table data can then be the input into a list of single input A-OALPs to obscure their values. This removes the direct relationship between the original plaintext and the newly created ciphertext, which is only used to create the plaintext-generating A-OALPs, not the original plaintext itself. The absence of a direct mapping between plaintext, ciphertext, and a key makes the method herein inherently resistant to brute-force, parallel, and quantum attacks, placing it in a different category from all known encryption schemes. Quantum attacks like Shor's and Grover's algorithms work when the encryption scheme has a mathematical key to plaintext relationship that can be inverted or searched, which is possible with AES, RSA, and ECC encryption models.

Not having a relationship between a key, plaintext, and ciphertext means that the Shannon confusion factor is always one (1). Unlike Shannon-style confusion (from data encryption systems), which seeks to obscure correlations between a key and the resulting ciphertext, the disclosed method achieves a higher-order form of obfuscation by removing the plaintext-ciphertext-key dependency entirely. Since the encryption process transforms algorithms into multidimensional, reversible A-OALP decompositions, no algebraic, statistical, or structural patterns that could be exploited by classical or quantum cryptanalysis are exposed.

FIG. 19 depicts two diagrams 310, 320 showing how “plaintext” can be encrypted, using a set of composed single input A-OALPs (a set of linked single input A-OALPs) as depicted by their associated output complexity, and decrypted using the set of composed single input A-OALPs. This is possible because the output complexity gives the same result as the A-OALP itself and multiple such single input A-OALPs are composable (linkable) and reversible. The first diagram 310 shows the transformation of a block of “plaintext,” \vec{p₁} 7312, using the output complexities of eight single input A-OALPs 314 arranged in a left linear fashion. The output vector of one output complexity is the input vector for its linked A-OALP output complexity. The second diagram 320 shows the reverse of each output complexity, effectively decrypting the encrypted “plaintext” 322. Reversing the output complexity 324 is possible because any single input A-OALP that is strictly monotonic is also continuous, differentiable, single-valued and directly reversible. The inverse output of one becomes the input to the linked inverse output complexity. For any single input A-OALP, instead of the output complexity, either the advanced time complexity T(a) or the advanced space complexity 2(m) curve fits can be substituted for the output complexity as they share the same attributes as output complexity.

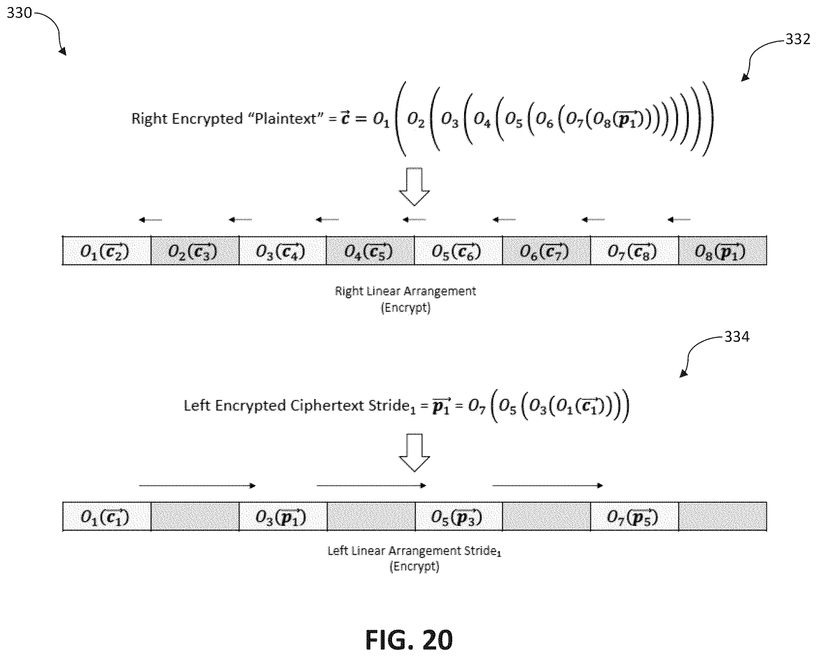

FIG. 20 is a depiction 330 that first shows a right linear linked single input A-OALP arrangement 332 and the second a left linear linked single input A-OALP arrangement 334 with a stride of one, both used to encrypt a “plaintext.” Since these are linear single input A-OALP arrangements, skipping over every other A-OALP, as occurs when a stride₁ is in force, decreases the overall number of linked single input A-OALPs used.

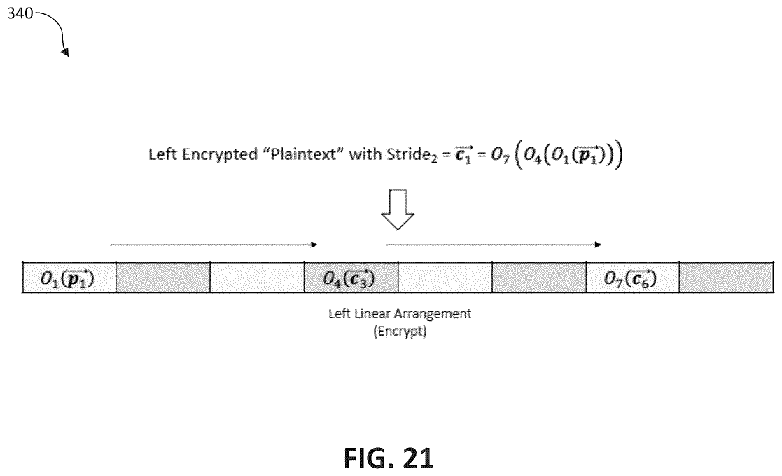

FIG. 21 is a depiction 340 showing a left linear linked single input A-OALP arrangement used to encrypt a “plaintext.” Here a stride₂ which skips two single input A-OALPs, is used, giving an even smaller number of linked single input A-OALPs.

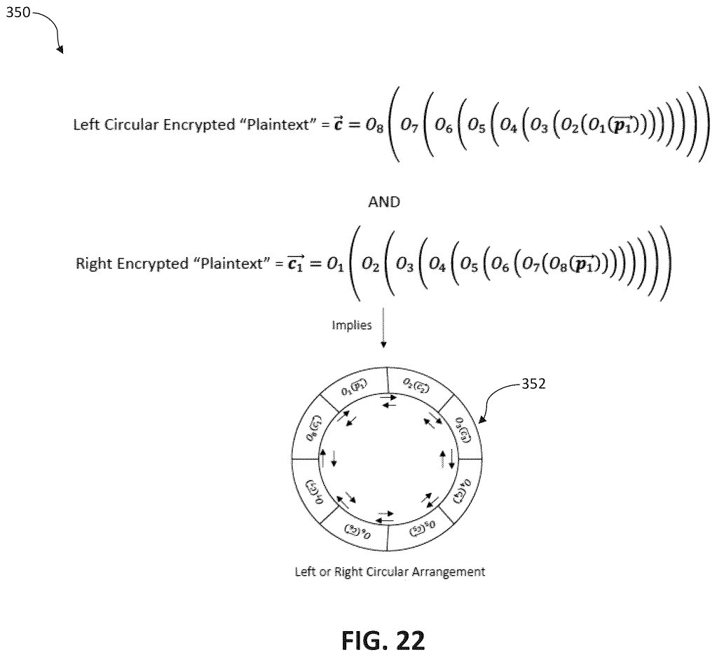

FIG. 22 is a depiction 350 showing a left and right circular linked single input A-OALP arrangement. This ring 352 allows for changes in the composite encryption function without decreasing the number of linked single input A-OALPs, as would occur with linear arrangements of single input A-OALPs. Although not shown, toroidal and spherical arrangements can be used in place of the circular arrangement of single input A-OALPs.

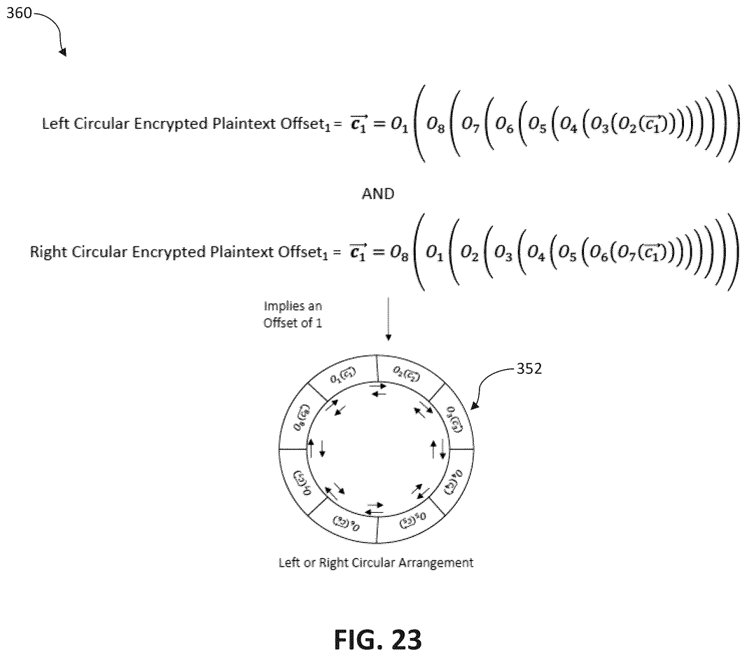

FIG. 23 is a depiction 360 showing that a left and right circular linked single input A-OALP arrangement can, like linear arrangements, have an offset of the starting position.

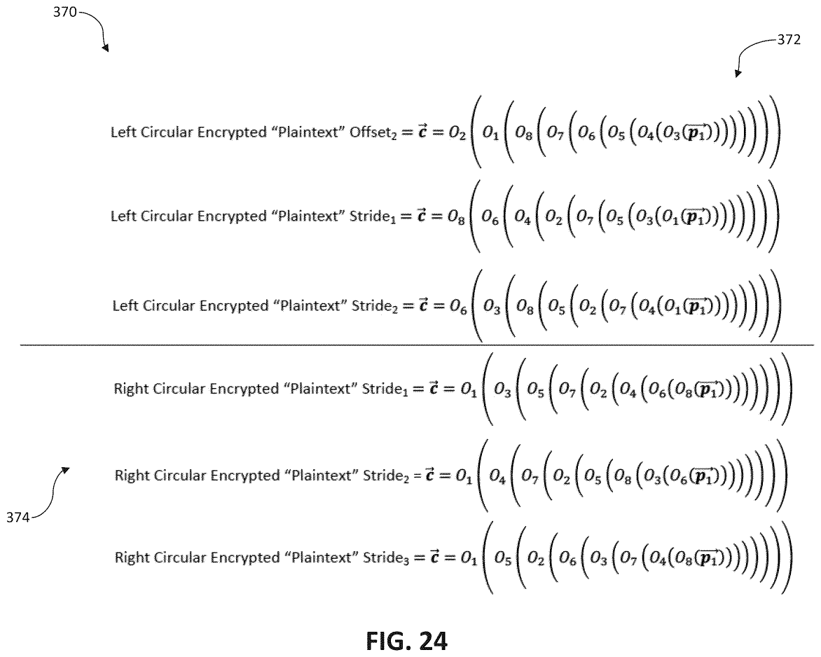

FIG. 24 is a depiction 370 showing two sets of linked single input A-OALPs 372, 374. The first set (above the line) 372 shows a left circular arrangement of linked single input A-OALPs with an offset of two. In addition, there is a left circular arrangement of linked single input A-OALPs with a stride of one (every other A-OALP) and a left circular arrangement of linked single input A-OALPs with a stride of two (every third A-OALP). For those arrangements with a stride, the circular arrangement is accessed in a helical fashion, ensuring that only unique A-OALPs are used, that is, no duplications. The second set of linked A-OALPs (below the line) 374 shows right circular linked single input A-OALP arrangements with strides of one, two, and three.

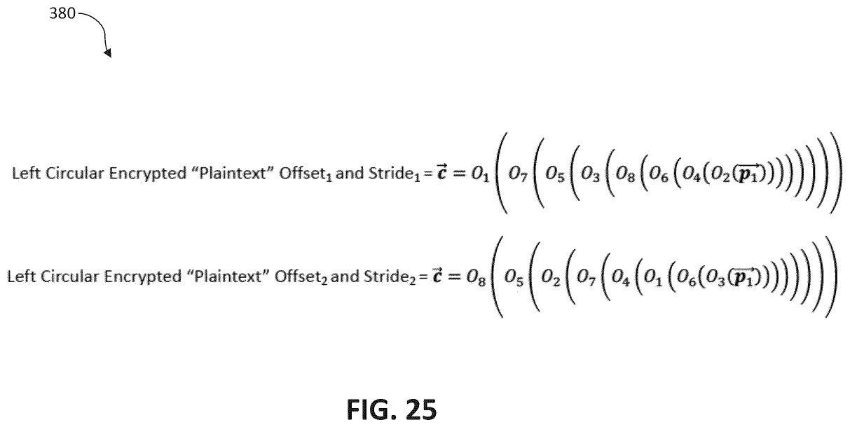

FIG. 25 is a depiction 380 showing two left circular linked single input A-OALPs: the first with an offset of one and a stride of one and the second with an offset of two and a stride of two.

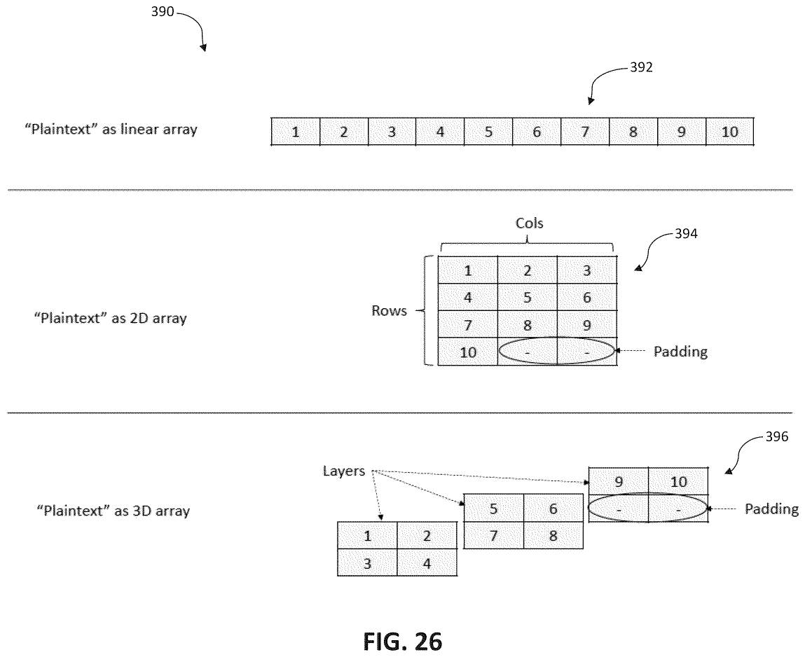

FIG. 26 is a depiction 390 showing “plaintext,” which can be values from a source values table, first arranged linearly 392. The linear view is then folded into a two-dimensional array 394, with added padding, which is then shown to be further folded into a three-dimensional array 396, also with padding. Folding up the “plaintext” further obscures the “plaintext” values as one must know the dimensionality of the “plaintext” in order to decrypt it. Each dimension exposed increases both the parallel processing and the data-obscuring opportunities because each “plaintext” dimension can use a different arrangement of linked single input A-OALPs, each of which can be separately processed.

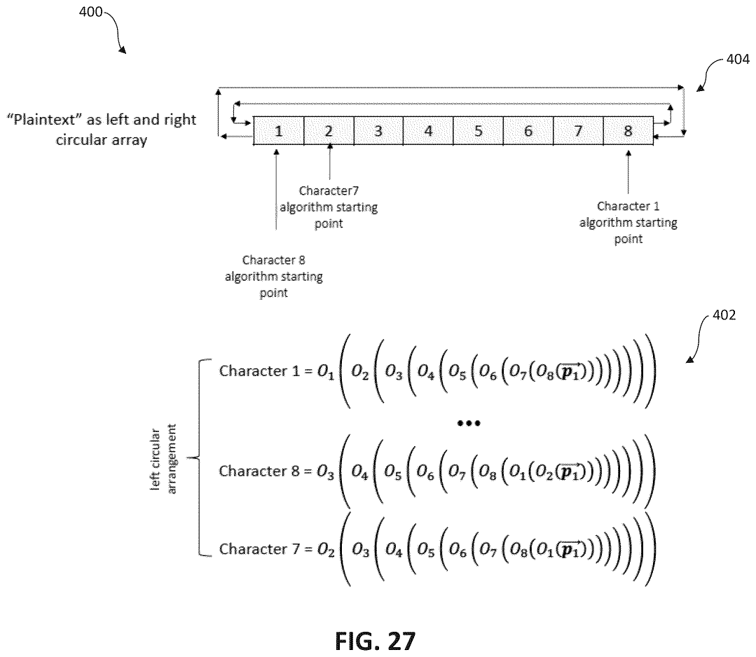

FIG. 27 is a depiction 400 showing the starting point of a left circular arrangement 402 of linked single input A-OALPs 404 and indicates that each “plaintext” character is encrypted using a different complex algorithm comprised of linked single input A-OALPs with various offsets and strides. As long as the pattern changes are synchronized to both the encryption and decryption parties, safe encryption and decryption can take place.

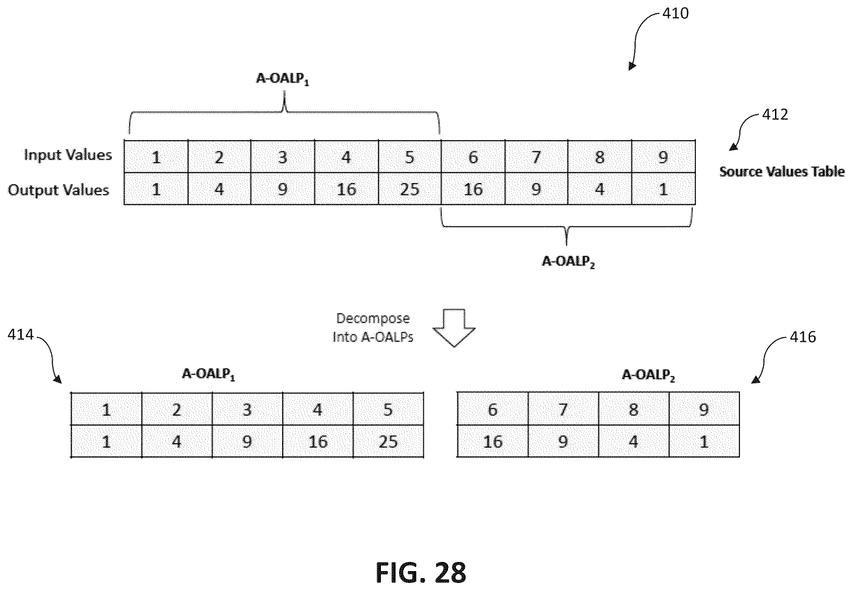

FIG. 28 is a diagram 410 showing an example of the initial stage of an A-OALP-based multidimensional encryption. First, the input/output value pairs are generated, producing a non-monotonic source values table 412. This non-monotonic source values table is discretized into two monotonic A-OALP source values tables 414, 416 using various methods. This means that there can be separate source values tables for different input dataset values for the same algorithm. Which A-OALP is active is a function of the inflection points of the output complexity curve. This has the effect of further obscuring the underlying transformational space for the encryption.

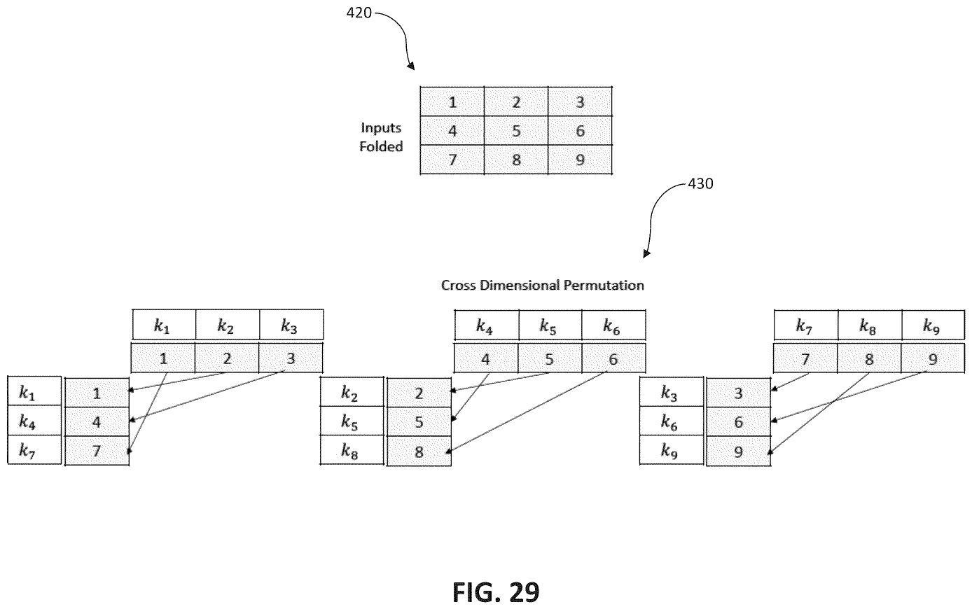

FIG. 29 shows two diagrams 420, 430: the first 420 of a 2-dimensional folded set of input values and the second 430 of permutations across the dimensions of the folded set of input values. It is possible to construct a key whose purpose is to allow for cross-dimensional permutations, further obscuring the original “plaintext” and making it seem as though standard encryption methods were being used.

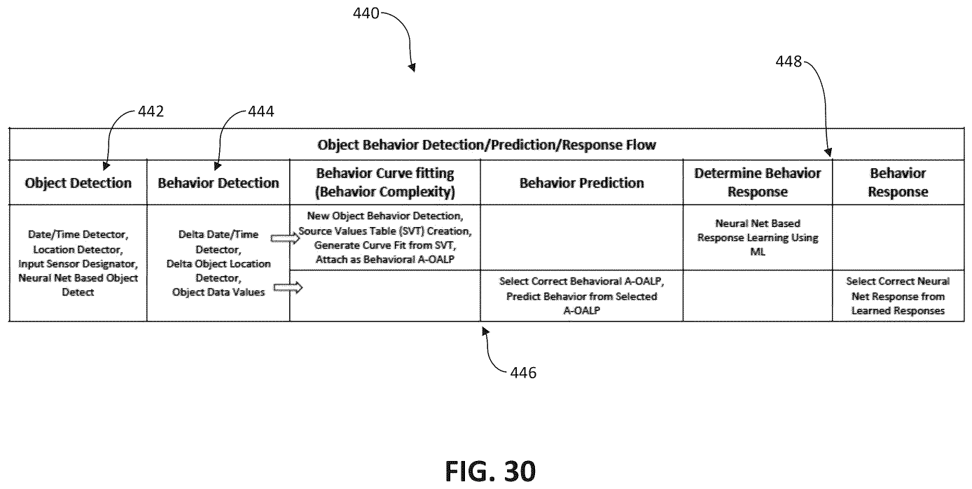

Referring to FIG. 30 through FIG. 35, in a system of A-OALPs, an object is defined to be a set of spatially and temporally correlated invariances. Each invariance corresponds to a detectable trait. The set of detectable traits is called herein an object's identifier. An object can also have aspects that change, that is, variable value changes, like position, movement, rotation, interaction with other objects, and other aspects that are detectable and reflect an object's behavior. Since changes only occur over time, they can be organized as input-output pairs in source values tables where time is the input and a detected variable change is the output. Since a source values table can be transformed into an output complexity or a set of linked output complexities, which in turn can be converted to an A-OALP or a set of linked A-OALPs, detected changes in variable values associated with objects can be stored as A-OALPs or linked A-OALPs. The output complexities of these A-OALPs are called herein object behaviors or behavior complexities because they represent the behavior of objects. Since A-OALPs that receive the same inputs and generate the same output represent the same A-OALP, two objects with variables whose source values tables are the same represent the same behavior for both objects.

As previously discussed, an A-OALP framework has three states: output complexity, advanced time complexity, and resource complexity. Consider advanced speedup:

$$Advance Speedup$$

$$\vec{{a}_{n}} = \frac{\vec{{a}_{1}}}{n} n = \frac{\vec{{a}_{1}}}{\vec{{a}_{n}}} , \qquad Equation 9$$

$$s ( n ) = \frac{{t}_{1} \times units}{{t}_{n} \times units} = \frac{{t}_{1}}{{t}_{n}} = T ( \frac{\vec{{a}_{1}}}{\vec{{a}_{n}}} ) = T ( n )$$

$$Where :$$

$$\vec{{a}_{1}} = value of input variables on one processing element that affect the number of loop iterations ,$$

$$\vec{{a}_{n}} = value of input variables on n processing elements that affect the number of loop iterations ,$$

$$n = the number of times the input variable values are divided by , equal to the number of processing elements$$

$$T ( n ) = scaled advanced time complexity$$

Advanced speedup or scaled advanced time complexity was generated by profiling an algorithm written in a particular computer language running on a particular operating system on a particular hardware. For larger codes, this profiling can take significant time. Consider that an A-OALP is a continuous, differentiable, single-valued, monotonic mathematical function as are the three states of output, advanced time, and resource complexity from the framework in FIG. 13. Below the relationship between advanced time complexity and resource complexity across multiple hardware-software stacks is discussed.

Advanced speedup herein represents not a time speedup metric but instead the path length of the geometry of processing time, that is, the path length of the shape or curve of time at a point representing a particular arbitrary but valid set of input dataset values. This separates the processing time generated from profiling on any particular hardware-software stack from the geometry of time; that is, the geometry of the advanced time complexity, not the advanced time complexity itself, is inherent to an A-OALP. To calculate physical time from temporal geometry requires finding the speed of traversal (SOT), that is, how fast processing occurs with a particular system hardware-software stack (CPU/GPU/tensor processing unit (TPU) clock rate, memory, processing elements, etc., as well as the operating system and language used). The SOT requires, instead of a full profile, only a single execution of the A-OALP with the minimum possible value, that is, the value where at least one looping structure in the A-OALP approaches a single loop iteration, which occurs when the input values equal the minimum possible values, amin:

$$Speed of Traversal$$

$$SOT = {lim}_{a \to {a}_{min}} \frac{t ( a )}{T ( a )} \qquad Equation 10$$

This gives:

$$New Advanced Time Complexity$$

$$t \times units = T ( \frac{\vec{{a}_{1}}}{\vec{{a}_{m ι n}}} ) \times SOT \qquad Equation 11$$

An A-OALP defines a temporal geometry T(⋅) that maps input-driven loop structure and parallelism to a dimensionless path length (advanced speedup). At any input dataset value point, physical execution time on a given hardware-software stack is obtained by multiplying the temporal geometry by a stack-specific speed-of-traversal, empirically determined from a minimal-time execution of the same A-OALP. In other words, once the temporal geometry is captured (via a source values table), a single calibration run per hardware-software stack suffices to predict the A-OALP's performance for arbitrary inputs on that stack. This means that the processing performance of a learned behavior can also be determined.

Consider how resource complexity R impacts speed of traversal. In order calculate the SOT for a given resource, a resource penalty coefficient is required for each resource because each resource decreases the effect of parallelism. If the SOT without considering resources is SOT₀=SOT, if f R=0, then the calculation of a SOT for a single resource considered is

$$k = \frac{SOT - {SOT}_{1}}{{SOT}_{1} \times {R}_{1}} ,$$

which can be expanded for multiple resources. For example, two resources give:

$$k = \frac{{SOT}_{2} - {SOT}_{1}}{{SOT}_{1} \times {R}_{1} - {SOT}_{2} \times {R}_{2}} .$$

$$Speed of Traversal Given Resource Complexity$$

$$SOT ( R ) = \frac{SOT}{1 + kR} \qquad Equation 12$$

$$Where : SOT = baseline speed of traversal ,$$

$$R = resource complexity ,$$

$$k = particular resource - penalty coefficient$$

Giving the resource-adjusted physical time:

$$Advance Time Complexity Given Speed of Traveral with Resource Complexity$$

$$t = T ( \cdot ) \times \frac{SOT}{1 + kR} \qquad Equation 13$$

This means that the impact of any required resources needed by a learned behavior can be quickly determined. It should be noted that the time prediction calculation using SOT(R) is applicable for any A-OALP, not just for object behavior-sourced A-OALPs.

Since an object's behavior can be represented by A-OALPs and sets of linked A-OALPs, then detecting object behaviors is equivalent to detecting the algorithms or source code for an object. This offers a unique method of automatically generating the algorithms used by any object from observation alone, representing a self-learning model that does not require big data training.

FIG. 30 is a diagram 440 showing an object's behavioral flow over time. First an object, defined by a set of spatially and temporally correlated invariances, is detected and identified 442 using neural network-based generative AI methods. The multiple detection of the same object over time allows for the creation of input-output pairs that are used to define the object's behavior 444, and those pairs are stored in a source values table. Then monotonic segments of values are identified, and a new source values table generated for each segment. The input-output pairs for each monotonic segment are transformed 446 using curve fits into continuous, differentiable, single-valued monotonic curves; that is, A-OALPs are generated and linked together, creating the behavioral complexity associated with an object. Like multi-input variable output complexity, the behavioral complexity is reversible when advanced outputs are used and can be executed using classical, parallel, one-way, and two-way quantum circuits. Multiple behavioral complexities can be combined as nodes in an A-OALP-based neural network for an object. Behavioral response 448 can now be defined as the predicted outcome of a set of linked behavioral complexities.

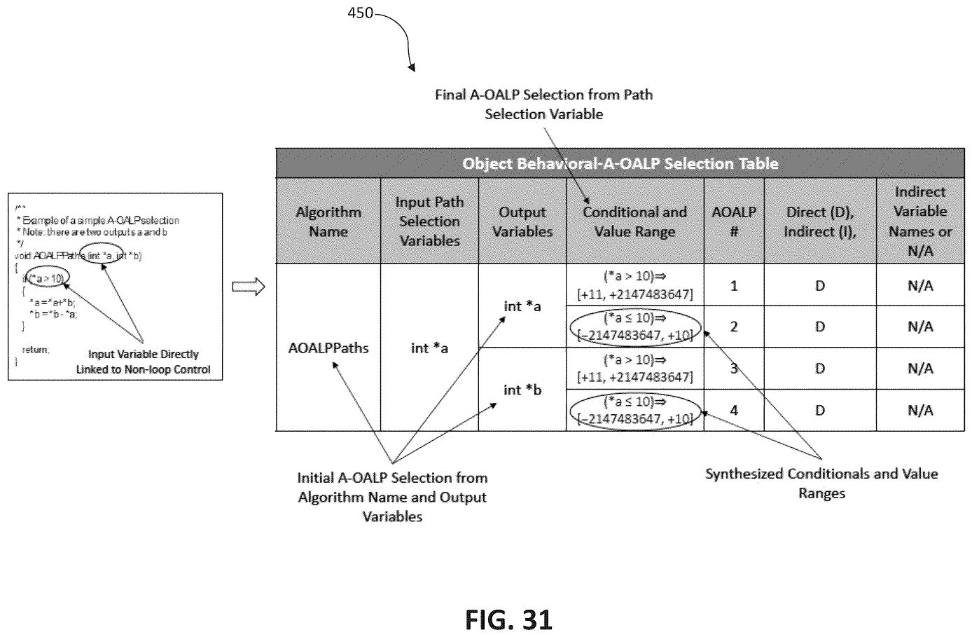

FIG. 31 is a diagram 450 showing that behavioral complexities can be selected from sets of input variables in the same way as standard A-OALPs. This means that it is possible to select a set of linked A-OALPs or an algorithm automatically from detected input variables, eliminating the need for classical scheduling; that is, it removes the normal analysis and scheduling typically performed by operating systems. It also removes the need for human-in-the-loop processing requests or predetermined actions. Combining automatic A-OALP selection from input values with the ability to perform self-learning within the constraints of the behavior complexities of an object means safe, fully autonomous, direct learning and response by the observing system.

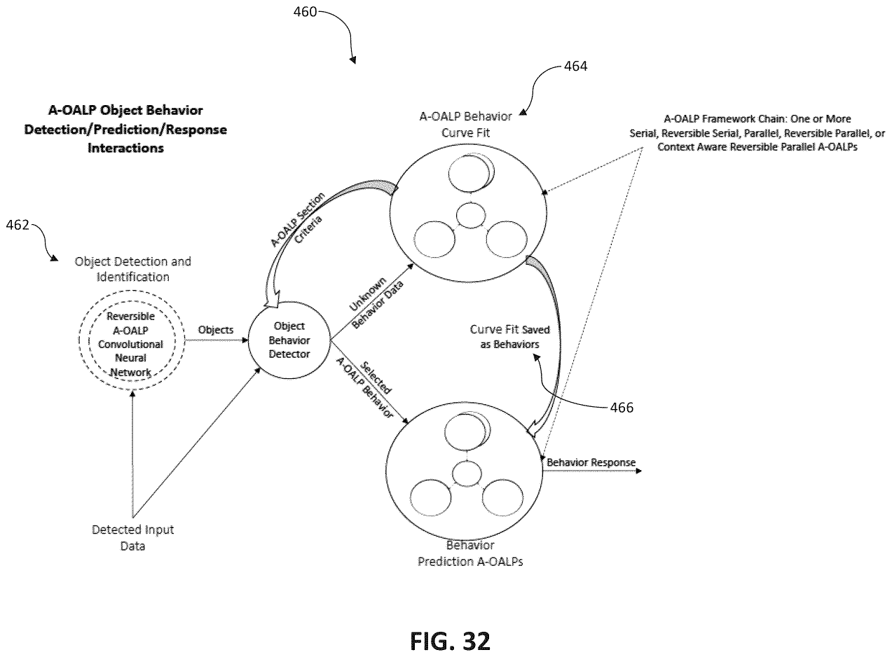

FIG. 32 is a diagram 460 showing the relationship between reversible A-OALP convolutional neural networks used to identify objects, object behavior detection, and either the construction of new behavior complexities or the use of stored behavior complexities in object behavior prediction. First, an object must be identifiable 462. The identification over a wide variety of detection conditions is used to train a neural network. As discussed above, for a detected object, the changes in the input-output variable values over time are used to generate the source values tables from which curve fits 464 are used to generate behavior complexity. The various behavior complexities are saved 466 for automatic activation, given the proper input dataset values. Since A-OALPs or a set of linked A-OALPs are reversible, any generated behavior can be reversed, making decisions safe.

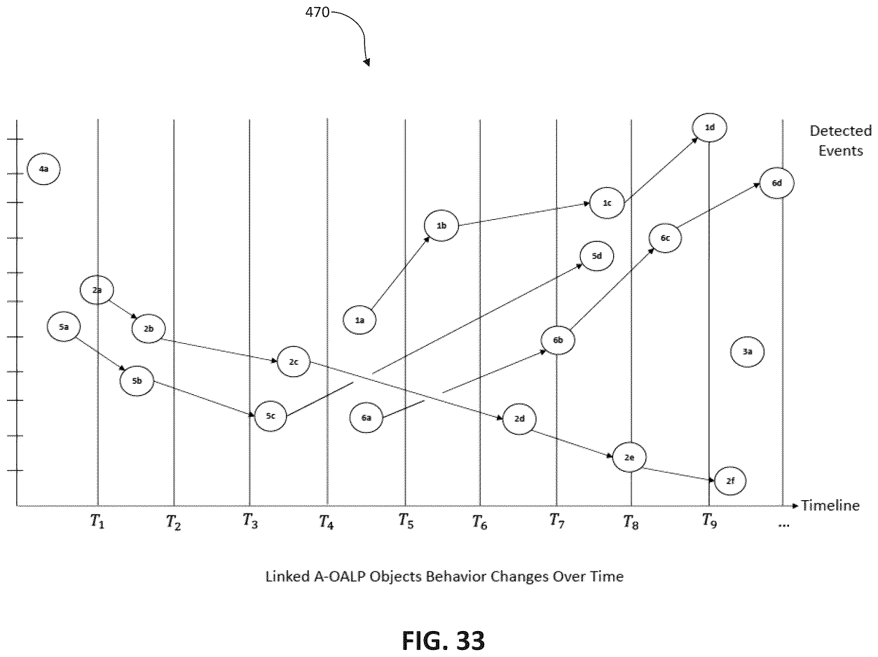

FIG. 33 is a graph 470 of multiple overlapping object behaviors. This graph indicates that, as long as there are either multiple objects evolving over time or different aspects of the same object evolving over time then simultaneous behavior complexities can be detected and processed. Since multiple behaviors can be tracked and predicted, an object's more complex behaviors can be inferred.

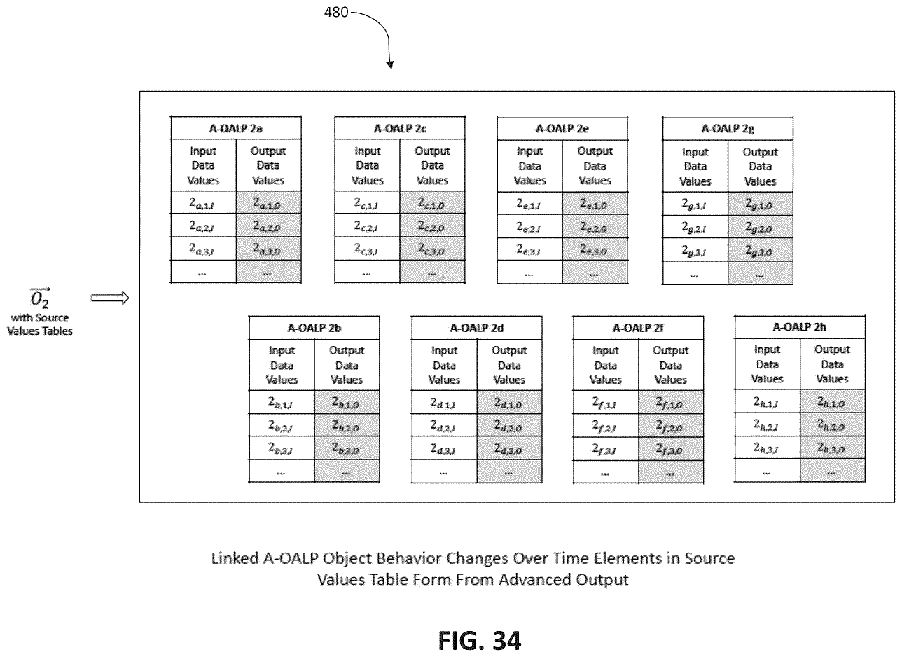

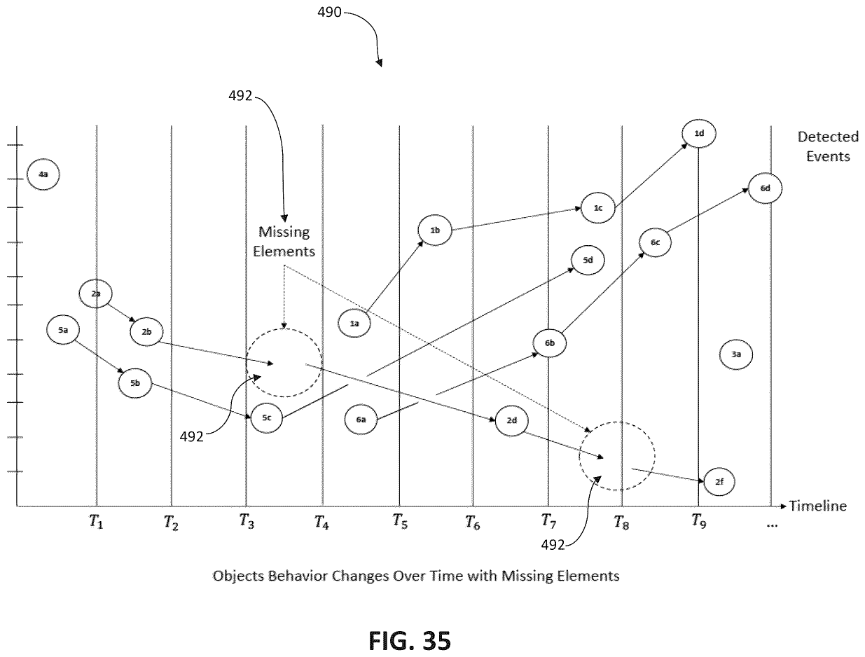

FIG. 34 is a diagram 480 showing that linked A-OALP object behaviors can be represented not only as source code or behavior complexity but also a list of source values tables. The source values table representation of object behaviors can be used to identify missing behavioral elements since linked behavior complexities are linked A-OALPs. Any set of linked A-OALPs can determine missing processing (behavior elements) and recover such processing as shown in FIG. 35.

FIG. 35 is a diagram 490 of multiple sets of linked object behaviors or behavior complexities, depicted as linked A-OALPs. One of the linked A-OALPs, A-OALP 2, shows multiple missing transformations 492, identified because the output of the preceding does not match the input of the succeeding. This could be because there was no sensor data available, processing did not occur, or any number of other reasons. If a new source values table is generated using the output of the preceding A-OALP and the input of the succeeding A-OALP, a curve fit of this newly generated source values table becomes the missing A-OALP.

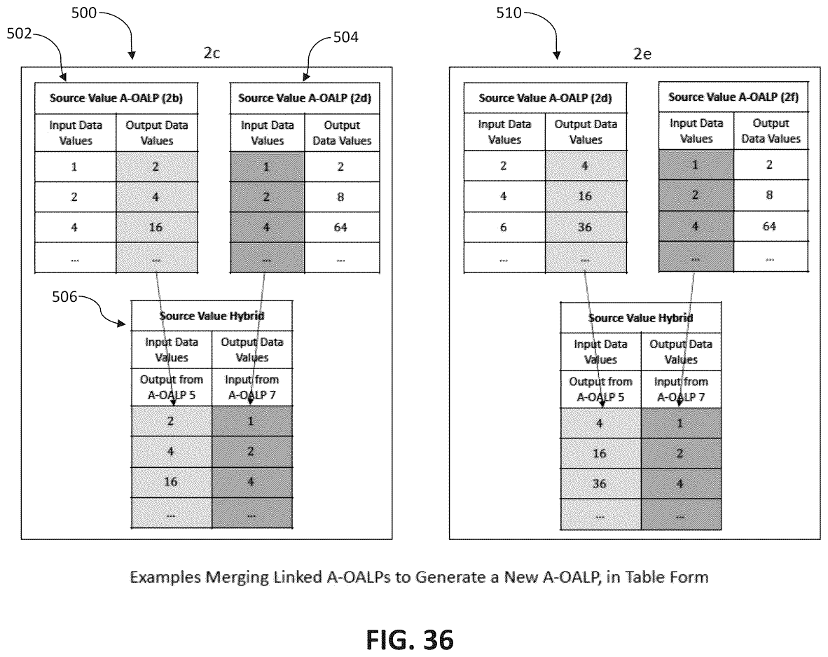

FIG. 36 shows the two sets of source values tables 500, 510, one for A-OALP 2b to A-OALP 2d 500 and one for A-OALP 2d to A-OALP 2f 510 of the diagram in FIG. 35. The missing A-OALPs are reconstructed by assuming that the source values tables represent end points. The output data values of the source values table of A-OALP 2b 502 are used as the input values of the missing source values table of A-OALP 2c 500 and the input values of the source values table of A-OALP 2d 504 are used as the output values of the missing source values table of A-OALP 2c 500. This new source values table 506 defines a potential A-OALP that bridges the two known A-OALPs. As long as the resulting A-OALP meets the criteria of an A-OALP then it is the missing A-OALP. The same technique is shown to recover A-OALP 2e 510. The ability to reconstruct A-OALPs means that it is possible to extend the concept of error recovery to include the direct recovery of large portions of a complex algorithm. This is an advancement over checkpointing or error correction codes, which only work on output data recovery, not recovery of the data transformation itself.

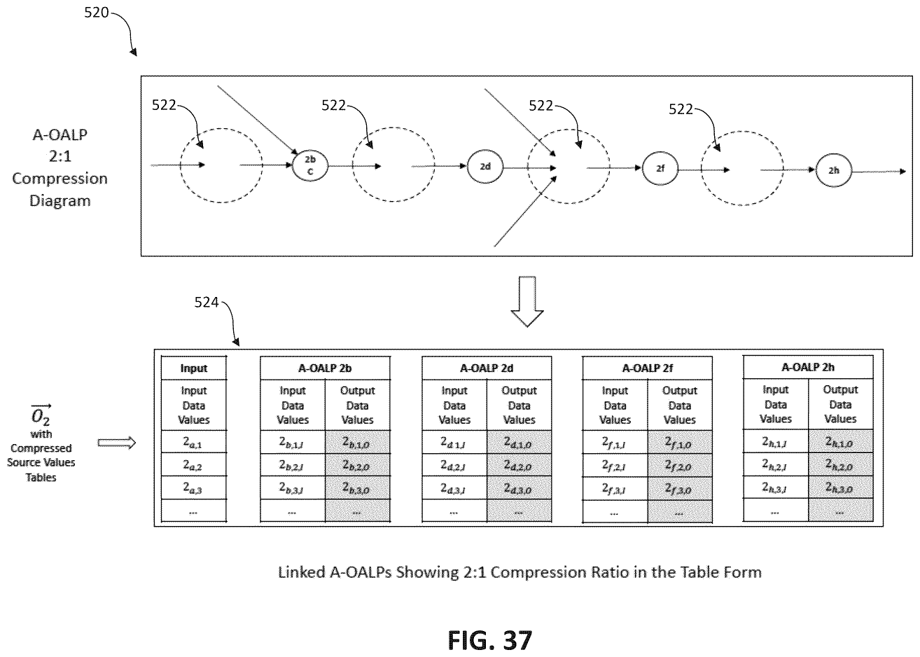

FIG. 37 is a diagram 520 with a list of linked A-OALPs whereby every other A-OALP 522 is missing. Since intermediate A-OALPs can be automatically generated using the technique described in the previous figures, then the missing A-OALPs can be recovered. If a full algorithm consists of a set of linked A-OALPs then that algorithm can be compressed by half, as demonstrated with the compressed source values tables 524. That is a 2:1 compression ratio at the transformation level. However, the actual compression ratio for any output data can be much higher because the output data is regenerated from the compressed linked A-OALPs.

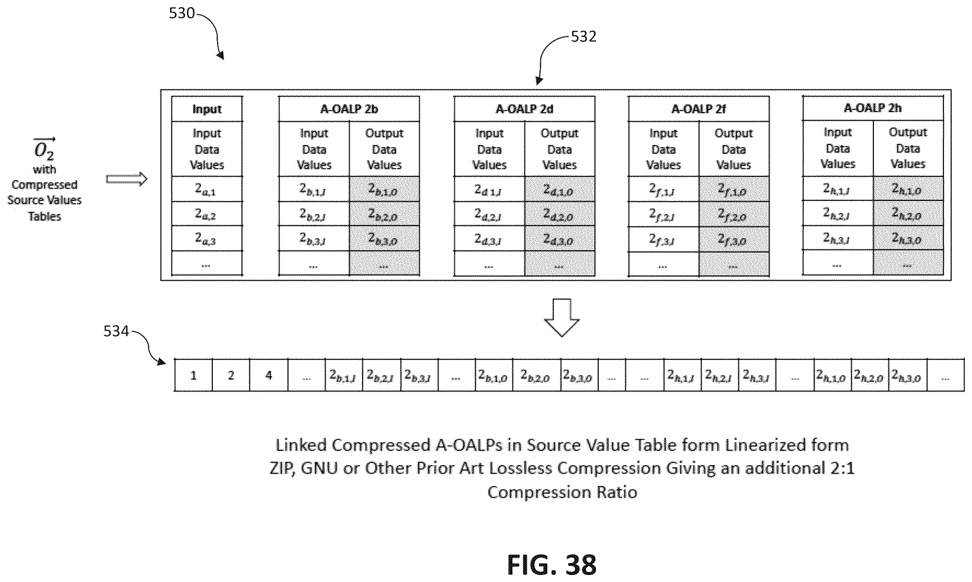

FIG. 38 is a diagram 530 showing that since the A-OALP-based algorithm compression is in linked source values table form 532, it can be further compressed using lossless compression methods (Huffman coding, Lempel-Ziv-Welch, Run-Length Encoding, and Deflate) 534 to obtain another 2:1 compression ratio at the transformation (algorithm) level. Thus, A-OALP-based algorithmic compression can have up to a 4:1 lossless compression ratio at the transformation level.

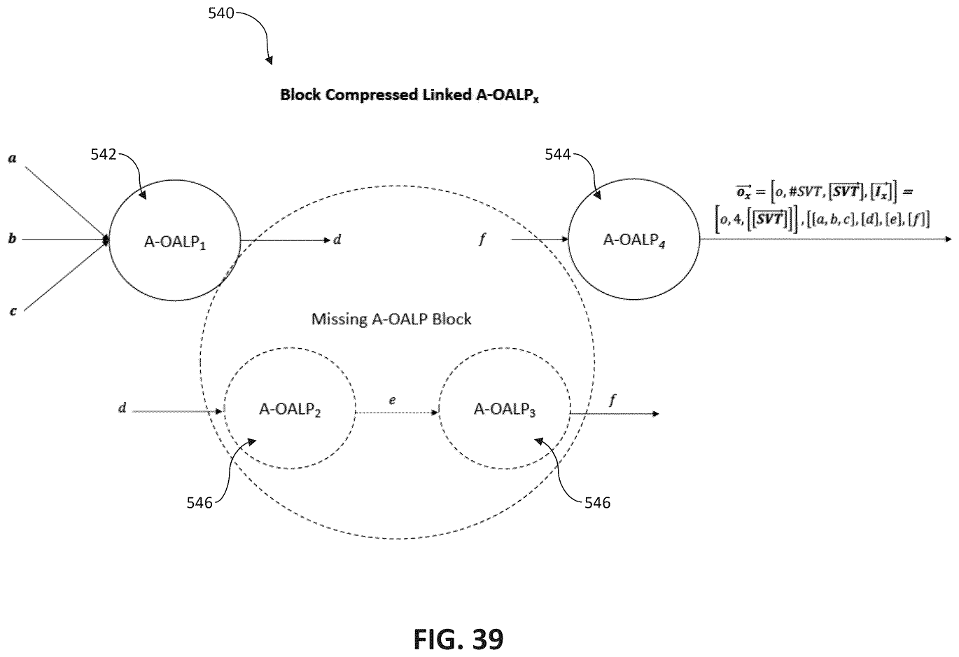

FIG. 39 is a diagram 540 of an expanded A-OALP-based algorithmic compression. Instead of removing every other A-OALP as previously shown, this version removes all A-OALPs between the first, A-OALP₁542, and the last, A-OALP₄544. The intervening A-OALPs 546 are recoverable because A-OALP₄ 544 generates an advanced output that contains not just the standard output, but also a vector of all inputs. Advanced output has the format:

$$Advanced Output Definition$$

$${o}_{x} = [ o , \# SVT , [ \vec{SVT} ] , [ \vec{{I}_{x}} ] ] \qquad Equation 14$$

$$Where {o}_{x} = advanced output vector for A - OALP x ,$$

$$o = standard output ,$$

$$\# SVT = total number of A - OALPs in A - OALP x ,$$

$$[ \vec{SVT} ] = input source values tables for all A - OALPs ,$$

$$[ \vec{{I}_{x}} ] = input vector containing all inputs .$$

Consider that the advanced output can contain the input and output source values tables for all intervening A-OALPs and that an A-OALP can be reconstituted from a source values table. This means that, as long as the last A-OALP generates an advanced output containing the vector of source values tables of the intervening A-OALPs then those A-OALPs can be reconstituted. It should be noted that if the A-OALPs are known and stored, then only an index to the A-OALP or its constituent source values table is required to reconstitute the entire block of linked A-OALPs between some first and some last A-OALP.

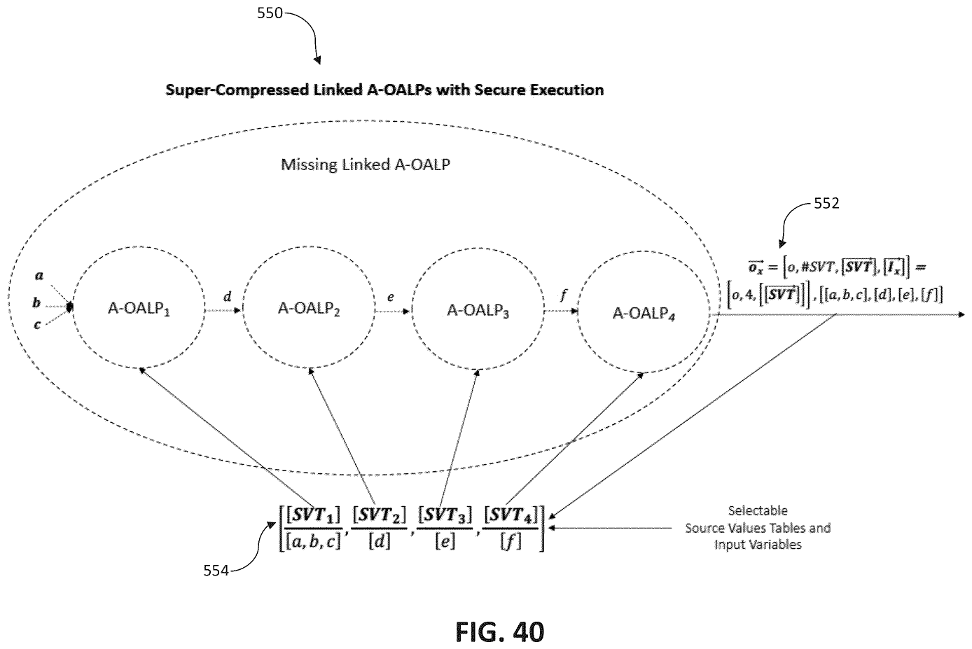

FIG. 40 is a diagram 550 showing A-OALP supercompression. With supercompression there are no A-OALPs, only the advanced output 552 with the source values tables (SVTs) of the last A-OALP. It should be noted that each of the source values tables in the advanced output 552 of the last A-OALP is in the order of execution, and are, therefore, individually selectable using an index into the list of SVTs 554. Consider that if an SVT is selected, it can be used, along with its associated input variables, to regenerate that particular A-OALP. If the regenerated A-OALP is then immediately executed while the following A-OALP is being regenerated, then it is possible to only have the current and next A-OALP visible at any one time, provided the memory is reused. This means that unlike standard compression techniques that must be decompressed prior to use, or standard encryption techniques that must be fully decrypted before use, in this method compressed and encrypted codes can be executed with only the minimum (two A-OALP) code segments ever exposed. This method, called secure execution, not only ensures secure transmission of networks and codes but also their secure execution. Safe execution only requires program memory for the current and next A-OALP, greatly decreasing memory requirements.

It is possible to use super-compressed linked A-OALPs with secure execution to be operating system-less (OS-less) where the security guarantees arise not from an operating system, privilege hierarchy, or isolation boundary, but from the algebraic structure of computation. With secure execution the machine never holds a complete, inspectable representation of the program or its state but instead provides execution as a sequence of ephemeral algebraic reductions in which only the currently active term exists in material form. If a computation is represented as a sequence of compressed codes or reductions C₀→C₁→ . . . →Cₙ, the system ensures that at any time t, only Cₜ is instantiated, and Cₜ₋₁ is erased as a function of the transition. No residual information about Cₜ₋₁ persists in memory.

In classical systems, the operating system exists to enforce isolation between processes, mediate access to memory, and maintain a privileged kernel that supervises execution. OS-less secure execution removes these OS requirements by ensuring that the machine never contains the algorithm in a form that can be read, copied, or reconstructed. With OS-less execution, the algorithm is encoded as a set of linked A-OALPs, each of which are mathematical functions that only exist long enough to compute the corresponding step. This structure eliminates the attack surfaces that operating systems were invented to manage because there is no persistent representation of the program. The security of the system is a consequence of an algebraic execution model rather than a function of the layered defenses of operating systems. The system enforces the idea that the observable machine state remains constant across all execution steps so that A-OALP execution introduces no new information into the observable state that could be exploited.

OS-less execution also eliminates the need for virtual machines and offers an execution substrate that maps an algorithm directly into a machine state, making it non-injective and non-surjective. This property means that the system achieves security not by restricting access to sensitive material but by ensuring that sensitive material does not exist within program memory.

In various embodiments, a DACS method is provided for real-time execution of software represented as A-OALPs. The method provides processing and memory resources, associates each A-OALP with time and resource complexity information, and receives start and due times for execution. An A-OALP selection table selects one or more A-OALPs based on input variable attributes, and a maximum number of processing elements is computed using the complexity values. The selected A-OALPs are transmitted to a resource checker that predicts processing time and generates a go/no-go signal relative to the due time. When sufficient resources are indicated, execution of the selected A-OALPs is initiated, and processing elements are dynamically reallocated to compensate for late data arrival or upstream delays, enabling deterministic real-time behavior without reliance on a conventional operating system scheduler.

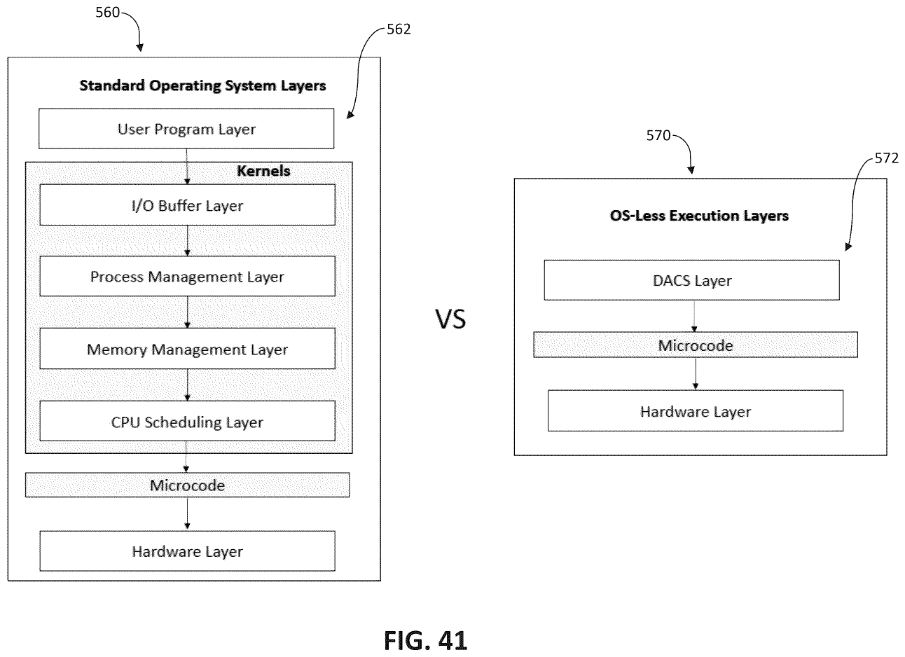

FIG. 41 shows two diagrams 560, 570, the first of a standard seven-layer 562 software execution system, which includes operating system kernels. An example user's software code accesses the kernel codes of an operating system to process input/output data (1/O buffer layer), load code and define the code's entry point (process management layer), allocate and deallocate cache and RAM (memory management layer), and schedule the start and end times of a user program (CPU scheduling layer). The operating system kernels directly activate microcode functions that generate both the hardware registers and the low-level gate logic required to perform the steps outlined in the user's software code. The OS-less system 570 has only three layers 572. The first is the distributed adaptive cooperative scheduler (DACS) layer that selects the algorithm to be executed, then using the input variable values, a particular pathway (A-OALP) within that algorithm is activated. The resources required to process the A-OALP are allocated using information from the resource complexity state of the current A-OALP. This includes calculating pₘₐₓ and using that to determine the actual resource allocation (cache, number of processing cores, and memory allocation) for the A-OALP. Next, the output complexity of the selected A-OALP, which represents the transformation function plus its data, is directly translated by the DACS into microcode functions that generate both hardware registers and low-level gate logic. Sequencing through linked A-OALPs is performed by DACs, activating the A-OALPs in order.

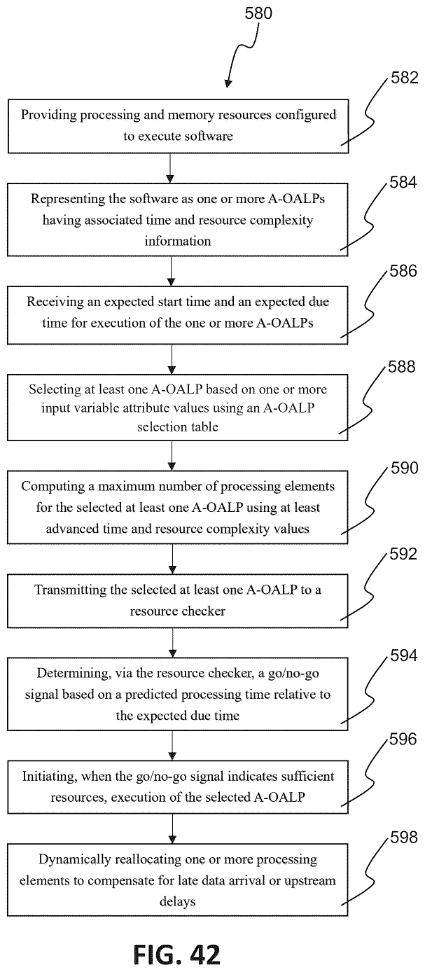

FIG. 42 is a process flow depicting, with other concepts, systems, and methods of the present invention, a method 580 for real-time execution of software represented as A-OALPs, with various DACS methods comprising: providing processing and memory resources configured to execute software (step 582), representing the software as one or more A-OALPs having associated time and resource complexity information (step 584), receiving an expected start time and an expected due time for execution of the one or more A-OALPs (step 586), selecting at least one A-OALP based on one or more input variable attribute values using an A-OALP selection table (step 588), computing a maximum number of processing elements for the selected at least one A-OALP using at least advanced time and resource complexity values (step 590), transmitting the selected at least one A-OALP to a resource checker (step 592), determining, via the resource checker, a go/no-go signal based on a predicted processing time relative to the expected due time (step 594), initiating, when the go/no-go signal indicates sufficient resources, execution of the selected A-OALP (step 596), and dynamically reallocating one or more processing elements to compensate for late data arrival or upstream delays (step 598).

In various embodiments the resource checker is associated with a server.

In various embodiments, the resource checker is a resource checker table comprising at least stored performance data used to predict a processing time for the selected at least one A-OALP.

In various embodiments, the resource checker is a resource checker table storing at least predicted fastest start times for linked A-OALPs.

In various embodiments, one or more heap space-time variables are generated to detection production-consumption conflicts between the one or more linked A-OALPs.

In various embodiments, one or more temporal conflicts are resolved by increasing a processing element count for a producer, or delaying a consumer start time.

In various embodiments, the method further comprises executing the one or more A-OALPs in an operating system (OS)-less execution environment.

In various embodiments, the method further comprises using advanced output to reconstruct missing one or more A-OALPs in a linked sequence.

In various embodiments, the method further comprises performing secure execution by decompressing a currently executing A-OALP and a next A-OALP.

In various embodiments, the method further comprises managing energy use as a resource by selecting a number of processing elements for execution of the selected at least one A-OALP or linked A-OALPs to satisfy an energy use level or an energy constraint level.

In one or more embodiments from the perspective of a computing system for real-time execution of software represented as A-OALPs, one or more processing elements operatively connected to memory are configured to: (i) provide processing and memory resources configured to execute software; (ii) represent the software as one or more A-OALPs having associated time and resource complexity information; (iii) receive an expected start time and an expected due time for execution of the one or more A-OALPs; (iv) select at least one A-OALP based on one or more input variable attribute values using an A-OALP selection table; (v) compute a maximum number of processing elements for the selected at least one A-OALP using at least advanced time and resource complexity values; (vi) transmit the selected at least one A-OALP to a resource checker; (vii) determine, via the resource checker, a go/no-go signal based on a predicted processing time relative to the expected due time; (viii) initiate, when the go/no-go signal indicates sufficient resources, execution of the selected A-OALP; and (ix) dynamically reallocate one or more processing elements to compensate for late data arrival or upstream delays

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

It will be recognized by one skilled in the art that operations, functions, algorithms, logic, method steps, routines, sub-routines, and modules may be implemented in software, in firmware, in special purpose digital logic, and any combination thereof without deviating from the spirit and scope of the present invention as recited within the claims attached hereto.

The present invention may be embodied in other specific forms without departing from the spirit or essential attributes thereof, and it is, therefore, desired that the present embodiment be considered in all respects as illustrative and not restrictive. Similarly, the above-described methods, steps, apparatuses, and techniques for providing and using the present invention are illustrative processes and are not intended to be limited to those specifically defined herein. Further, features and aspects, in whole or in part, of the various embodiments described herein can be combined to form additional embodiments within the scope of the invention even if such combination is not specifically described herein.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112(f) are not to be invoked unless the specific terms “means for” or “step for” are recited in a claim.

Further, all patent applications, publications, and patents, and their corresponding disclosures and details, referenced or identified herein are hereby fully incorporated herein by reference.

What is claimed is:

1. A distributed adaptive cooperative scheduler (DACS) method, comprising:
providing processing and memory resources configured to execute software;
representing the software as one or more advanced output-affecting linear pathways (A-OALPs) having associated time and resource complexity information;
receiving an expected start time and an expected due time for execution of the one or more A-OALPs;
selecting at least one A-OALP based on one or more input variable attribute values using an A-OALP selection table;
computing a maximum number of processing elements for the selected at least one A-OALP using at least advanced time and resource complexity values;
transmitting the selected at least one A-OALP to a resource checker;
determining, via the resource checker, a go/no-go signal based on a predicted processing time relative to the expected due time;
initiating, when the go/no-go signal indicates sufficient resources, execution of the selected A-OALP; and
dynamically reallocating one or more processing elements to compensate for late data arrival or upstream delays.

2. The method of claim 1, wherein the resource checker is associated with a server.

3. The method of claim 1, wherein the resource checker is a resource checker table comprising at least stored performance data used to predict a processing time for the selected at least one A-OALP.

4. The method of claim 1, wherein the resource checker is a resource checker table storing at least predicted fastest start times for linked A-OALPs.

5. The method of claim 4, wherein one or more heap space-time variables are generated to detection production-consumption conflicts between the one or more linked A-OALPs.

6. The method of claim 4, wherein one or more temporal conflicts are resolved by increasing a processing element count for a producer, or delaying a consumer start time.

7. The method of claim 1, further comprising executing the one or more A-OALPs in an operating system (OS)-less execution environment.

8. The method of claim 1, further comprising using advanced output to reconstruct missing one or more A-OALPs in a linked sequence.

9. The method of claim 1, further comprising performing secure execution by decompressing a currently executing A-OALP and a next A-OALP.

10. The method of claim 1, further comprising managing energy use as a resource by selecting a number of processing elements for execution of the selected at least one A-OALP or linked A-OALPs to satisfy an energy use level or an energy constraint level.

11. A distributed adaptive cooperative scheduler (DACS) system, comprising:
memory; and
one or more processing elements operatively connected to the memory, wherein the one or more processing elements are configured to execute software to:
represent the software as one or more advanced output-affecting linear pathways (A-OALPs) having associated time and resource complexity information;
receive an expected start time and an expected due time for execution of the one or more A-OALPs;
select at least one A-OALP based on one or more input variable attribute values using an A-OALP selection table;
compute a maximum number of processing elements for the selected at least one A-OALP using at least advanced time and resource complexity values;
transmit the selected at least one A-OALP to a resource checker;
determine, via the resource checker, a go/no-go signal based on a predicted processing time relative to the expected due time;
initiate, when the go/no-go signal indicates sufficient resources, execution of the selected A-OALP; and
dynamically reallocate at least one processing element to compensate for late data arrival or upstream delays.

12. The system of claim 11, wherein the resource checker is associated with a server.

13. The system of claim 11, wherein the resource checker is a resource checker table comprising at least stored performance data used to predict a processing time for the selected at least one A-OALP.

14. The system of claim 11, wherein the resource checker is a resource checker table storing at least predicted fastest start times for linked A-OALPs.

15. The system of claim 14, wherein one or more heap space-time variables are generated to detection production-consumption conflicts between the one or more linked A-OALPs.

16. The system of claim 14, wherein one or more temporal conflicts are resolved by increasing a processing element count for a producer, or delaying a consumer start time.

17. The system of claim 11, wherein the one or more processing elements are further configured to execute the one or more A-OALPs in an operating system (OS)-less execution environment.

18. The system of claim 11, wherein the one or more processing elements are further configured to use advanced output to reconstruct missing one or more A-OALPs in a linked sequence.

19. The system of claim 11, wherein the one or more processing elements are further configured to perform secure execution by decompressing a currently executing A-OALP and a next A-OALP.

20. The system of claim 11, wherein the one or more processing elements are further configured to manage energy use as a resource by selecting a number of processing elements for execution of the selected at least one A-OALP or linked A-OALPs to satisfy an energy use level or an energy constraint level.
